(19) United States
(12) Patent Application Publication
(10) Pub. No.: US 2026/0109155 A1
(43) Pub. Date: Apr. 23, 2026

(54) LIGHT SCANNING APPARATUS AND IMAGE FORMING APPARATUS INCLUDING THE SAME

(71) Applicant: CANON KABUSHIKI KAISHA, Tokyo (JP)

(72) Inventors: Hiroki YOSHIDA, Tochigi (JP); Kazumi KIMURA, Saitama (JP); Hayato KATO, Tochigi (JP)

(21) Appl. No.: 19/359,844

(22) Filed: Oct. 16, 2025

(30) Foreign Application Priority Data
Oct. 21, 2024 (JP) 2024-184625

(51) Int. Cl. B41J 2/47; B41J 2/44; G02B 26/12; G03G 15/04; G03G 15/041

(52) U.S. Cl. CPC B41J 2/471; B41J 2/44; G02B 26/125; G03G 15/04036; G03G 15/0415

(57) ABSTRACT

Provided is a light scanning apparatus including a deflecting unit, and a first optical system for guiding a light flux deflected by the deflecting unit to a surface to be scanned. A width of the light flux immediately before entering the deflecting unit is smaller than that of a deflecting surface of the deflecting unit in a main scanning cross section. Only a part of the light flux incident on the deflecting unit reaches a plurality of image heights on the surface via the deflecting surface in the main scanning cross section. A distance between an on-axis image height and an image height closest to the on-axis image height on one side and that between the on-axis image height and an image height closest to the on-axis image height on the other side, with respect to the on-axis image height among the plurality of image heights are appropriately set.

### BACKGROUND

### Field of the Technology

The present disclosure is related to a light scanning apparatus, and to a light scanning apparatus suitably used in an image forming apparatus such as a laser beam printer (LBP), a digital copying machine or a multi-function printer.

### Description of the Related Art

Conventionally, a light scanning apparatus has been used as an exposure apparatus mounted on an image forming apparatus such as a laser beam printer using an electrophotographic process.

The light scanning apparatus can be classified into an underfilled scan (UFS) type and an overfilled scan (OFS) type according to a relationship between a size of an incident light flux incident on a deflecting unit and that of a deflecting surface.

Specifically, in the UFS method, a width of the incident light flux incident on the deflecting unit is smaller than that of the deflecting surface of the deflecting unit in a main scanning cross section, whereas in the OFS method, the width of the incident light flux incident on the deflecting unit is larger than that of the deflecting surface of the deflecting unit in the main scanning cross section.

Japanese Patent Laid-open No. 2005-92129 discloses a light scanning apparatus employing the UFS method.

### SUMMARY

According to one aspect of the present disclosure, there is provided a light scanning apparatus including a deflecting unit configured to deflect a light flux from a light source to scan a surface in a main scanning direction, and a first optical system configured to guide the light flux deflected by the deflecting unit to the surface to be scanned. A width of the light flux immediately before being incident on the deflecting unit is smaller than a width of a deflecting surface of the deflecting unit in a main scanning cross section. Only a part of the light flux incident on the deflecting unit reaches a plurality of image heights on the surface to be scanned via the deflecting surface in the main scanning cross section. The following inequality is satisfied:

$$- 0.005 \leq ( Y 2 - Y 1 ) / ( Y 2 + Y 1 ) \leq 0.005$$

where Y1 (mm) represents a distance between an on-axis image height and an image height closest to the on-axis image height on one side with respect to the on-axis image height among the plurality of image heights, and Y2 (mm) represents a distance between the on-axis image height and an image height closest to the on-axis image height on the other side with respect to the on-axis image height among the plurality of image heights.

Features of the present disclosure will become apparent from the following description of embodiments with reference to the attached drawings. The following description of embodiments is described by way of example.

### BRIEF DESCRIPTION OF THE DRAWINGS

FIG. 1A is a main scanning cross sectional view of a light scanning apparatus according to a first embodiment of the present disclosure.

FIG. 1B is a partial sub-scanning cross sectional view of the light scanning apparatus according to the first embodiment.

FIG. 2 is a graph showing a rotation angle dependence of a position of a deflection point on a deflecting surface of a polygon mirror.

FIG. 3A is a graph showing a rotation angle dependence of an incident position of a light flux on the polygon mirror.

FIG. 3B is a graph showing a rotation angle dependence of an incident position of a light flux on the polygon mirror.

FIG. 4 is a graph showing a scanning line formed on a surface to be scanned when a surface tilting occurs in the polygon mirror in the light scanning apparatus according to the first embodiment.

FIG. 5A is a main scanning cross sectional view of a light scanning apparatus according to a second embodiment of the present disclosure.

FIG. 5B is a partial sub-scanning cross sectional view of the light scanning apparatus according to the second embodiment.

FIG. 6 is a graph showing a scanning line formed on a surface to be scanned when a surface tilting occurs in the polygon mirror in the light scanning apparatus according to the second embodiment.

FIG. 7A is a sub-scanning cross sectional view of a main part of a monochrome image forming apparatus according to the present disclosure.

FIG. 7B is a sub-scanning cross sectional view of a main part of a color image forming apparatus according to the present disclosure.

### DESCRIPTION OF THE EMBODIMENTS

Hereinafter, a light scanning apparatus according to the present disclosure is described in detail with reference to the accompanying drawings. Note that the drawings described below may be drawn on a scale different from the actual scale in order to facilitate understanding of the present disclosure.

In the following description, a main scanning direction is a direction perpendicular to a rotation axis of a polygon mirror 5 and an optical axis of an imaging optical system 7 (a direction in which a light flux is deflected by the polygon mirror 5), and a sub-scanning direction is a direction parallel to the rotation axis of the polygon mirror 5. Further, a main scanning cross section is a cross section parallel to the main scanning direction and the optical axis of the imaging optical system 7 (perpendicular to the sub-scanning direction), and a sub-scanning cross section is a cross section parallel to the sub-scanning direction and the optical axis of the imaging optical system 7 (perpendicular to the main scanning direction).

The present disclosure is related to a light scanning apparatus, and to a light scanning apparatus that records image information by deflecting a light flux emitted from a light source by a polygon mirror serving as a deflecting unit to scan a surface via an imaging optical system.

The light scanning apparatus according to the present disclosure is suitably used in an image forming apparatus such as a printer having an electrophotographic process, a digital copier or a multi-function printer.

### First Embodiment

Conventionally, when a light scanning apparatus is newly designed, it becomes easy to suppress an initial investment and to suppress a total cost as a product by using conventional components as much as possible with satisfying specifications.

For example, when higher speed and higher image quality are required as compared with the conventional ones, it is possible to suppress the initial investment by increasing the number of deflecting surfaces of a polygon mirror with using conventional optical elements.

On the other hand, if the number of deflecting surfaces of the polygon mirror is simply increased, it is considered that a size of the polygon mirror is increased or an optical performance is deteriorated, for example, a field curvature is generated by shifting a position of a deflection point with respect to a light flux incident on the deflecting surface.

Here, a case where a polygon mirror having five deflecting surfaces (hereinafter referred to as a five-surface polygon mirror) is used instead of a polygon mirror having four deflecting surfaces (hereinafter referred to as a four-surface polygon mirror) is considered.

In such case, it is possible to make a light flux less likely to be vignetted at an end of each deflecting surface of the five-surface polygon mirror by setting a width in the main scanning cross section of each deflecting surface of the five-surface polygon mirror to be equal to that of the four-surface polygon mirror.

On the other hand, in this case, a distance between a rotation center and a center of each deflecting surface in the five-surface polygon mirror is increased as compared with that in the four-surface polygon mirror.

For example, in the case of the four-surface polygon mirror having an outer diameter (length of diagonal line of a square) of 20 mm, the width in the main scanning cross section of each deflecting surface is 14.142 mm, and the distance between the rotation center and the center of each deflecting surface is 7.071 mm.

In the case of the five-surface polygon mirror in which the width in the main scanning cross section of each deflecting surface is 14.142 mm similarly to the four-surface polygon mirror, the outer diameter (length of diagonal line of a regular pentagon) is 24.060 mm, and the distance between the rotation center and the center of each deflecting surface are 9.732 mm.

When the five-surface polygon mirror is used instead of the four-surface polygon mirror such that the width in the main scanning cross section of each deflecting surface does not change, an area thereof projected in the main scanning cross section increases from 200 mm² to 344 mm², and a weight thereof also increases.

Therefore, in a case where a driving unit is not changed, a time required to reach a predetermined number of rotations when the five-surface polygon mirror is rotationally driven by the driving unit becomes longer than that required for the four-surface polygon mirror, which is not preferable.

In addition, the distance between the rotation center and the center of each deflecting surface also increases by 2.661 mm by using the five-surface polygon mirror instead of the four-surface polygon mirror such that the width in the main scanning cross section of each deflecting surface does not change.

Therefore, even if positions of deflection points at which a light flux is deflected so as to reach a predetermined image height on a predetermined deflecting surface are made to coincide with each other between the four-surface polygon mirror and the five-surface polygon mirror, the positions of the deflection points on another deflecting surface are different from each other since the positions of the rotation centers are different from each other.

Accordingly, when the five-surface polygon mirror is used instead of the four-surface polygon mirror such that the width in the main scanning cross section of each deflecting surface does not change, a position at which the light flux deflected at the deflection point at a position different from the position in the four-surface polygon mirror passes through an imaging optical system is also different from that in the four-surface polygon mirror. Therefore, an optical performance such as a focus position also changes.

When the five-surface polygon mirror is used instead of the four-surface polygon mirror such that the position of the rotation center does not change, the position of any deflection point on any deflecting surface changes, so that the optical performance changes more greatly.

Therefore, it is considered that the five-surface polygon mirror is used instead of the four-surface polygon mirror such that the distance between the rotation center and the center of each deflecting surface does not change.

For example, in a case that the five-surface polygon mirror is used instead of the four-surface polygon mirror with an outer diameter of 20 mm such that the distance between the rotation center and the center of each deflecting surface does not change, the outer diameter changes from 20 mm to 17.481 mm.

Further, the width in the main scanning cross section of each deflecting surface changes from 14.142 mm to 10.275 mm, and the area thereof projected in the main scanning cross section decreases from 200 mm² to 182 mm², and a weight thereof also decreases.

Therefore, in the case where a driving unit is not changed, the time required to reach a predetermined number of rotations when the five-surface polygon mirror is rotationally driven by the driving unit is shorter than that required for the four-surface polygon mirror.

Further, if the five-surface polygon mirror is used instead of the four-surface polygon mirror such that the distance between the rotation center and the center of each deflecting surface does not change and the position of the rotation center does not change, positions of deflection points on each deflecting surface do not change, so that the optical performance such as the focus position does not change.

On the other hand, when the five-surface polygon mirror is used instead of the four-surface polygon mirror having the outer diameter of 20 mm such that the distance between the rotation center and the center of each deflecting surface does not change, the width in the main scanning cross section of each deflecting surface is reduced from 14.142 mm to 10.275 mm as described above.

Therefore, a part of the incident light flux may be vignetted when it is deflected at an end on each deflecting surface of the five-surface polygon mirror depending on the light flux width in the main scanning direction of the incident light flux incident on the five-surface polygon mirror and the fθ coefficient of the imaging optical system.

Then, when the light flux, a part of which is vignetted by being deflected in this manner, reaches a surface to be scanned, density unevenness occurs in an image formed on the surface to be scanned, thereby an image quality is deteriorated since a light amount of the light flux is reduced in accordance with the vignetted amount.

In view of this, an object of the present embodiment is to provide a light scanning apparatus capable of suppressing such deterioration in image quality.

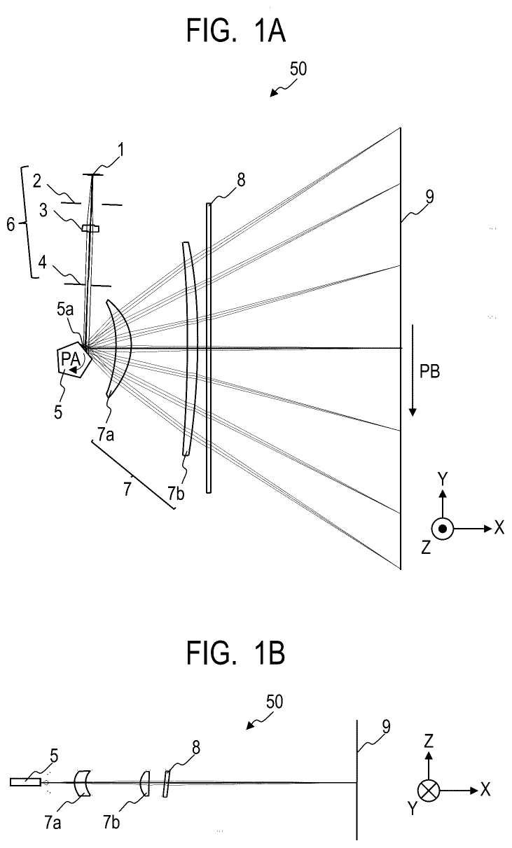

FIGS. 1A and 1B show a schematic main scanning cross sectional view and a partial schematic sub-scanning cross sectional view of a light scanning apparatus 50 according to a first embodiment of the present disclosure, respectively.

The light scanning apparatus 50 according to the present embodiment includes a light source 1, a sub-scanning stop 2, an anamorphic collimator lens 3, a main scanning stop 4, a polygon mirror 5, a first imaging lens 7a, a second imaging lens 7b and a dustproof glass 8.

As the light source 1, for example, a semiconductor laser having a single light emitting point is used. As described later, the light source 1 is shifted in the main scanning direction such that the single light emitting point thereof is not positioned on an optical axis of an incident optical system 6.

The sub-scanning stop 2 has a rectangular aperture, and regulates a width in the sub-scanning direction of a light flux emitted from the light source 1. A width in the main scanning direction of the light flux emitted from the light source 1 is also once regulated by passing through the sub-scanning stop 2.

The rectangular aperture formed in the sub-scanning stop 2 has a size of 2.40 mm in the main scanning direction and 1.29 mm in the sub-scanning direction.

The anamorphic collimator lens 3 converts the light flux that has passed through the sub-scanning stop 2 into a parallel light flux in the main scanning cross section and into a convergent light flux in the sub-scanning cross section.

Here, the parallel light flux includes not only a strictly parallel light flux but also a substantially parallel light flux such as a weakly convergent light flux or a weakly divergent light flux.

Further, in the light scanning apparatus 50 according to the present embodiment, temperature compensation is performed by forming an incident surface of the anamorphic collimator lens 3 as a diffracting surface.

The main scanning stop 4 has a rectangular aperture, and regulates again the light flux width in the main scanning direction of the light flux that has passed through the anamorphic collimator lens 3.

The rectangular aperture formed in the main scanning stop 4 has a size of 2.96 mm in the main scanning direction, and no structure for regulating the light flux width is formed in the sub-scanning direction.

The polygon mirror 5 is a rotary polygon mirror that serves as a deflecting unit for deflecting the light flux that has passed through the main scanning stop 4 toward a surface to be scanned 9.

Further, the polygon mirror 5 has five deflecting surfaces 5a and an outer diameter of 17.481 mm.

The polygon mirror 5 is rotated at a constant speed in a direction indicated by an arrow PA in FIG. 1A by a driving unit such as a motor (not shown).

In the light scanning apparatus 50 according to the present embodiment, a width of the light flux immediately before being incident on a deflecting surface 5a of the polygon mirror 5 is smaller than that of the deflecting surface 5a in the main scanning cross section.

The first imaging lens 7a and the second imaging lens 7b guide (condense) the light flux deflected by the deflecting surface 5a of the polygon mirror 5 onto the surface 9.

The dustproof glass 8 suppresses entry of a foreign substance such as dust from a surface 9 side in a housing (not shown) of the light scanning apparatus 50 according to the present embodiment, and also suppresses leakage of noise or the like generated in the driving unit for driving the polygon mirror 5 to an outside.

In the light scanning apparatus 50 according to the present embodiment, an incident optical system 6 (second optical system) is formed by the sub-scanning stop 2, the anamorphic collimator lens 3 and the main scanning stop 4.

Further, in the light scanning apparatus 50 according to the present embodiment, an imaging optical system 7 (first optical system) having the fθ characteristic is formed by the first imaging lens 7a and the second imaging lens 7b.

The imaging optical system 7 forms a so-called facet angle error compensation optical system that makes the deflecting surface 5a of the polygon mirror 5 and the surface 9 optically conjugate with each other in the sub-scanning cross section.

In the light scanning apparatus 50 according to the present embodiment, a light flux (divergent light flux) optically modulated in accordance with image information and emitted from the light source 1 passes through a rectangular aperture provided in the sub-scanning stop 2, thereby a part thereof is shielded in the sub-scanning direction, and a width in the sub-scanning direction thereof is regulated.

Next, the light flux that has passed through the sub-scanning stop 2 is converted into a substantially parallel light flux in the main scanning cross section, and is condensed such that a line image long in the main scanning direction is formed in the vicinity of the deflecting surface 5a of the polygon mirror 5 in the sub-scanning cross section by the anamorphic collimator lens 3.

A part of the light flux that has passed through the anamorphic collimator lens 3 is shielded in the main scanning direction by passing through a rectangular aperture provided in the main scanning stop 4, thereby a light flux width in the main scanning direction thereof is regulated, and then it is incident on the deflecting surface 5a of the polygon mirror 5.

The light flux deflected by the deflecting surface 5a of the polygon mirror 5 is condensed into a spot shape on the surface to be scanned 9 by the first imaging lens 7a and the second imaging lens 7b.

The light flux condensed into the spot shape scans the surface 9 at a constant speed in a direction indicated by an arrow PB in FIG. 1A, namely in the main scanning direction by a rotation of the polygon mirror 5 in the direction indicated by the arrow PA in FIG. 1A.

As a result, an image is recorded on a photosensitive surface of a photosensitive drum as a recorded medium arranged at a position of the surface 9.

Next, various numerical values such as curvature radii in the main scanning cross section and the sub-scanning cross section, a surface interval, and a refractive index of each optical element provided in the light scanning apparatus 50 according to the present embodiment are shown in the following Table 1.

TABLE 1

| | | | | n |
|---|---|---|---|---|
| | RY [mm] | RZ [mm] | D [mm] | (λ = 792 nm) |
| Light source 1 | | | 0.50 | |
| Incident surface of cover glass | ∞ | | 0.25 | 1.5105 |
| Exit surface of cover glass | ∞ | | 13.65 | |
| Sub-scanning stop 2 | ∞ | | 10.40 | |
| Incident surface of anamorphic collimator lens 3 | ∞ (diffracting surface) | | 3.00 | 1.5282 |
| Exit surface of anamorphic collimator lens 3 | −32.381 | −18.751 | 25.90 | |
| Main scanning stop 4 | ∞ | | 30.70 | |
| Deflecting surface 5a of polygon mirror 5 | ∞ | | 16.00 | |
| Incident surface of first imaging lens 7a | −34.420 | 13.000 | 6.70 | 1.5282 |
| Exit surface of first imaging lens 7a | −21.765 | 13.000 | 26.37 | |
| Incident surface of second imaging lens 7b | −800.000 | 20.100 | 3.50 | 1.5282 |
| Exit surface of second imaging lens 7b | 139.423 | −78.397 | 6.67 | |
| Incident surface of dustproof glass 8 | ∞ | | 1.83 | 1.5105 |
| Exit surface of dustproof glass 8 | ∞ | | 92.78 | |
| Surface to be scanned 9 | | | | |

In Table 1, Ry represents a curvature radius in the main scanning cross section, R_{Z} represents a curvature radius in the sub-scanning cross section, D represents a distance between adjacent optical surfaces, and n represents a refraction index for a light flux having a wavelength of 792 nm.

Further, aspheric coefficients of an incident surface and an exit surface provided in each of the first imaging lens 7a and the second imaging lens 7b provided in the light scanning apparatus 50 according to the present embodiment are shown in the following Table 2.

In Table 2, E+X indicates “x10^{+X}”, and this is similarly applied to the following tables.

TABLE 2

| Aspherical | Incident surface | Exit surface of | Incident surface | Exit surface of |
|---|---|---|---|---|
| surface | of first imaging | first imaging | of second | second imaging |
| coefficient | lens 7a | lens 7a | imaging lens 7b | lens 7b |
| RY | −3.442E+01 | −2.176E+01 | −8.000E+02 | 1.394E+02 |
| ku | −1.669E−04 | −1.179E+00 | 0 | −6.894E+01 |
| B3 | 0 | 0 | 0 | −1.194E−07 |
| B4 | 8.682E−06 | 1.618E−06 | 0 | −2.313E−06 |
| B5 | 0 | 0 | 0 | 3.651E−11 |
| B6 | 2.298E−08 | 1.062E−09 | 0 | 1.118E−09 |
| B7 | 0 | 0 | 0 | 3.002E−15 |
| B8 | −4.937E−11 | 4.350E−11 | 0 | −4.272E−13 |
| B9 | 0 | 0 | 0 | −1.074E−17 |
| B10 | 2.430E−15 | −8.671E−14 | 0 | 1.017E−16 |
| B11 | 0 | 0 | 0 | 3.012E−21 |
| B12 | 0 | 0 | 0 | −1.086E−20 |
| Rz | 1.300E+01 | 1.300E+01 | 2.010E+01 | −7.840E+01 |
| D1 | 0 | 0 | −3.629E−03 | 1.208E−02 |
| D2 | 0 | −6.263E−04 | 6.127E−04 | −2.598E−04 |
| D3 | 0 | 0 | −2.506E−06 | −1.744E−05 |
| D4 | 0 | 6.079E−06 | 7.052E−08 | −1.302E−08 |
| D5 | 0 | 0 | 2.136E−09 | 1.457E−08 |
| D6 | 0 | −2.342E−08 | −1.620E−10 | 2.381E−10 |
| D7 | 0 | 0 | 1.056E−12 | −7.480E−12 |
| D8 | 0 | 4.329E−11 | 1.380E−14 | −1.649E−13 |
| D9 | 0 | 0 | −1.462E−15 | 2.155E−15 |
| D10 | 0 | −2.525E−14 | 5.373E−17 | 3.792E−17 |
| D11 | 0 | 0 | 3.127E−19 | −2.450E−19 |
| D12 | 0 | 0 | −1.683E−20 | −1.686E−21 |
| M0_1 | 0 | 0 | 1.222E−01 | 1.250E−01 |
| M1_1 | 0 | 0 | −2.554E−05 | −2.026E−06 |
| M2_1 | 5.904E−04 | 5.636E−04 | 9.684E−05 | 4.238E−05 |
| M3_1 | 0 | 0 | 2.570E−08 | 6.133E−08 |
| M4_1 | −3.626E−06 | −1.141E−06 | −1.759E−07 | −6.762E−08 |
| M5_1 | 0 | 0 | −1.998E−11 | −1.011E−10 |
| M6_1 | 6.318E−09 | −4.677E−09 | 1.034E−10 | 2.828E−11 |
| M7_1 | 0 | 0 | 2.553E−14 | 7.097E−14 |
| M8_1 | −6.274E−12 | 9.288E−12 | −2.966E−14 | −5.017E−15 |
| M9_1 | 0 | 0 | −1.233E−17 | −1.924E−17 |
| M10_1 | 1.001E−14 | 0 | 3.260E−18 | 4.072E−20 |
| M0_4 | 0 | 0 | 0 | −1.377E−04 |
| M1_4 | 0 | 0 | 0 | 5.070E−06 |
| M2_4 | 0 | 0 | 0 | 2.746E−07 |
| M3_4 | 0 | 0 | 0 | −3.784E−09 |
| M4_4 | 0 | 0 | 0 | −1.484E−10 |
| M5_4 | 0 | 0 | 0 | 8.911E−13 |
| M6_4 | 0 | 0 | 0 | 3.737E−14 |

Specifically, shapes in the main scanning cross section of the incident surface and the exit surface of each of the first imaging lens 7a and the second imaging lens 7b provided in the light scanning apparatus 50 according to the present embodiment are expressed by the following Expression (1):

$$X = \frac{\frac{{Y}^{2}}{{R}_{Y}}}{1 + \sqrt{1 - ( 1 + {k}_{u} ) {( \frac{y}{{R}_{Y}} )}^{2}}} + {\sum }_{i = 3}^{12} {B}_{i} {Y}^{i} . \qquad ( 1 )$$

In Expression (1), a direction parallel to the optical axis of the imaging optical system 7 is defined as an X direction, a main scanning direction is defined as a Y direction, and a sub-scanning direction is defined as a Z direction. The above definitions are similarly applied to the following expressions.

Further, shapes in the sub-scanning cross section of the incident surface and the exit surface of each of the first imaging lens 7a and the second imaging lens 7b provided in the light scanning apparatus 50 according to the present embodiment are expressed by the following Expression (2):

$$S ( Y , Z ) = \frac{\frac{{Z}^{2}}{{r}_{Z}^{′}}}{1 + \sqrt{1 - {( \frac{Z}{{r}_{Z}^{′}} )}^{2}}} + {\sum }_{j = 0}^{16} {\sum }_{k = 1}^{8} {M}_{j k} {Y}^{j} {Z}^{k} . \qquad ( 2 )$$

In Expression (2), S (Y,Z) represents a sag amount at a coordinate (Y,Z) from a meridional shape at a position of a coordinate Y when a surface vertex of each optical surface is set as the origin, and an actual shape of the optical surface is X+S (Y,Z).

Further, r_{Z}′ represents a curvature radius in the sub-scanning cross section at a position of a coordinate Y on a meridional line of each optical surface in Expression (2), and is specifically expressed by the following Expression (3):

$${r}_{Z}^{′} = {r}_{Z} ( 1 + {\sum }_{l = 1}^{12} {D}_{l} {Y}^{l} ) . \qquad ( 3 )$$

Furthermore, a phase function φ of a diffracting surface formed on an incident surface of the anamorphic collimator lens 3 provided in the light scanning apparatus 50 according to the present embodiment is expressed by the following Expression (4):

$$ϕ = ( \frac{2 π}{λ} ) \times ( {CY}^{2} + {EZ}^{2} ) . \qquad ( 4 )$$

In Equation (4), λ represents a design wavelength (790 nm), and C and E represent phase coefficients shown in the following Table 3.

TABLE 3

| Phase | Incident surface of |
|---|---|
| coefficient | anamorphic collimator lens 3 |
| C | −1.197E−02 |
| E | −1.489E−02 |

In a diffraction grating on the diffracting surface formed on the incident surface of the anamorphic collimator lens 3, a step having a height at which an optical path length has a difference corresponding to the wavelength is provided at coordinates at which the phase function φ is an integral multiple of 2π.

Further, a coordinate of a surface vertex and an angle of a surface normal of each optical surface in the light scanning apparatus 50 according to the present embodiment are shown in the following Table 4.

TABLE 4

| | | | | Angle of normal | Angle of normal |
|---|---|---|---|---|---|
| | X coordinate | Y coordinate | Z coordinate | in main scanning | in sub-scanning |
| | [mm] | [mm] | [mm] | cross section [°] | cross section [°] |
| Light source 1 | 3.404 | 84.332 | 0 | −92.5 | 0 |
| Sub-scanning | 3.053 | 69.933 | 0 | −92.5 | 0 |
| stop 2 | | | | | |
| Incident surface | 2.600 | 59.543 | 0 | −92.5 | 0 |
| of anamorphic | | | | | |
| collimator lens 3 | | | | | |
| Main scanning | 1.524 | 34.912 | 0 | −92.5 | 0 |
| stop 4 | | | | | |
| Rotation axis of | −5.747 | −4.222 | 0 | | |
| polygon mirror 5 | | | | | |
| Incident surface | 16.000 | 0 | 0 | 0 | 0 |
| of first imaging | | | | | |
| lens 7a | | | | | |
| Incident surface | 49.073 | 0 | 0 | 0 | 0 |
| of second | | | | | |
| imaging lens 7b | | | | | |
| Incident surface | 59.246 | 0 | 0 | 0 | −9.53 |
| of dustproof | | | | | |
| glass 8 | | | | | |
| Surface to be | 153.848 | 0 | 0 | 0 | 0 |
| scanned 9 | | | | | |

For the angle of the surface normal of each of the first imaging lens 7a and the second imaging lens 7b shown in Table 4, the aspherical shape defined by the aspheric coefficients shown in Table 2 is not considered.

Further, the position of the light source 1 shown in Table 4 is considered to be shifted by 0.278 mm in an orientation away from the surface to be scanned 9 of a direction perpendicular to the optical axis of the incident optical system 6, as described later.

Next, characteristic structures and effects of the light scanning apparatus 50 according to the present embodiment are described.

Specifically, a case is considered in which a polygon mirror 5 having an inscribed circle radius of 7.071 mm and five deflecting surfaces 5a is used instead of the polygon mirror 5′ having an inscribed circle radius of 7.071 mm and four deflecting surfaces 5a.

However, the present disclosure is not limited thereto, and the structure described below can be similarly applied to, for example, a case where a polygon mirror having a predetermined inscribed circle radius and six deflecting surfaces 5a is used instead of a polygon mirror having the predetermined inscribed circle radius and five deflecting surfaces 5a.

That is, the structure described below can be applied to a case where a polygon mirror having a predetermined inscribed circle radius and (N+1) deflecting surfaces 5a is used instead of a polygon mirror having the predetermined inscribed circle radius and N deflecting surfaces 5a.

Further, the structure described below can also be applied to a case where a polygon mirror having a second inscribed circle radius and (N+1) deflecting surfaces 5a is used instead of a polygon mirror having a first inscribed circle radius and N deflecting surfaces 5a.

Specification values of each of the polygon mirror 5′, the polygon mirror 5, and the polygon mirror 5″ are shown in the following Table 5.

TABLE 5

| | Polygon | Polygon | Polygon |
|---|---|---|---|
| | mirror 5′ | mirror 5 | mirror 5″ |
| Number of deflecting | 4 | 5 | 5 |
| surfaces 5a | | | |
| Outer diameter [mm] | 20 | 17.481 | 24.06 |
| Inscribed circle radius | 7.071 | 7.071 | 9.732 |
| [mm] | | | |
| Width in main scanning | 14.142 | 10.275 | 14.142 |
| cross section of | | | |
| deflecting surface 5a | | | |
| [mm] | | | |
| Area when projected in | 200 | 181.6 | 344.1 |
| main scanning cross | | | |
| section [mm²] | | | |

Specifically, the polygon mirror 5′ has four deflecting surfaces 5a and an inscribed circle radius of 7.071 mm.

Further, the polygon mirror 5 has five deflecting surfaces 5a with the same inscribed circle radius of 7.071 mm as the polygon mirror 5′.

Furthermore, the polygon mirror 5″ has five deflecting surfaces 5a with the same width of 14.142 mm in the main scanning cross section of the deflecting surfaces 5a as the polygon mirror 5′.

For example, in the polygon mirror 5″, the incident light flux may be vignetted depending on the conditions since the inscribed circle radius is larger than that of the polygon mirror 5′ while the width in the main scanning cross section of the deflecting surface 5a is maintained.

That is, in order to prevent the incident light flux from being vignetted by the polygon mirror 5″ under any condition, it is necessary to increase the width in the main scanning cross section of the deflecting surface 5a in accordance with the increase in the inscribed circle radius.

On the other hand, in the polygon mirror 5″, an area of the deflecting surface 5a projected in the main scanning cross section is already increased by 1.7 times or more while the width in the main scanning cross section thereof is maintained as compared with the polygon mirror 5′.

That is, a weight of the polygon mirror 5″ is larger than that of the polygon mirror 5′, so that a time required to reach a predetermined number of rotations when the polygon mirror 5″ is rotated is also increased.

If a power of a driving means for rotationally driving the polygon mirror 5″ is increased in order to suppress the increase in the time, a cost increases, which is not preferable.

Further, even when the polygon mirror 5′ and the polygon mirror 5″ are arranged such that positions of the deflection points on the deflecting surface 5a with respect to a principal ray of a light flux for scanning a predetermined image height coincide with each other, positions of rotation centers are different from each other due to the difference in a magnitude of the inscribed circle radius.

Accordingly, the positions of the deflection points on the deflecting surface 5a when the polygon mirror 5′ and the polygon mirror 5″ are rotated by the same angle are different from each other.

Here, for the sake of simplicity, it is assumed that an angle between an optical axis of the incident optical system 6 and an optical axis of the imaging optical system 7 in the main scanning cross section is 90°.

In addition, a case where the polygon mirror 5′ and the polygon mirror 5″ are arranged such that positions of deflection points (hereinafter, referred to as on-axis deflection points) on the deflecting surface 5a with respect to a principal ray of a light flux (hereinafter, referred to as an on-axis light flux) for scanning an on-axis image height coincide with each other is considered.

At this time, the rotation center of the polygon mirror 5″ is shifted from that of the polygon mirror 5′ by a difference between inscribed circle radii, namely 2.661 mm, in a direction of 45° (in a direction away from the light sources 1 and the surface to be scanned 9).

Next, a case where a predetermined polygon mirror is rotated such that an angle between a normal of a predetermined deflecting surface 5a and an optical axis of the incident optical system 6 becomes smaller by φ [°] with respect to a reference angle when the predetermined deflecting surface 5a deflects the on-axis light flux in the predetermined polygon mirror is considered.

It is assumed that an inscribed circle diameter of the predetermined polygon mirror is r, and a position of a principal ray of a light flux incident on the predetermined polygon mirror is shifted by “a” from the rotation center of the predetermined polygon mirror 5 toward the surface to be scanned 9.

First, when the angle φ is 0°, a position of a deflection point (namely, on-axis deflection point) on the deflecting surface 5a with respect to the principal ray of the light flux incident on a predetermined polygon mirror is separated from the rotation center of the predetermined polygon mirror by the following amount in a direction parallel to the optical axis of the incident optical system 6:

$$\sqrt{2} \times r - a .$$

Here, the amount is positive in an orientation approaching the light source 1.

Then, a case where the predetermined polygon mirror rotates by φ [°] as described above is considered.

At this time, the position of the deflection point on the deflecting surface 5a with respect to the principal ray of the light flux incident on the predetermined polygon mirror is separated from the rotation center of the predetermined polygon mirror by the following amount in the direction parallel to the optical axis of the incident optical system 6:

$$\frac{r}{sin ( ϕ + 4 {5}^{∘} )} - \frac{a}{tan ( ϕ + 4 {5}^{∘} )} .$$

Therefore, when the predetermined polygon mirror is rotated by φ [°], the position of the deflection point on the deflecting surface 5a with respect to the principal ray of the light flux incident on the predetermined polygon mirror is shifted toward the light source 1 by the following amount in the direction parallel to the optical axis of the incident optical system 6:

$$[ \frac{r}{sin ( ϕ + 4 {5}^{∘} )} - \frac{a}{tan ( ϕ + 4 {5}^{∘} )} ] - [ \sqrt{2} \times r - a ] .$$

Here, when the shift amount “a” in the polygon mirror 5′ is 5 mm, the shift amount “a” in the polygon mirror 5″ is calculated as the following equation (5):

$$a = 5 + \frac{2.661}{\sqrt{2}} = 6.882 mm . \qquad ( 5 )$$

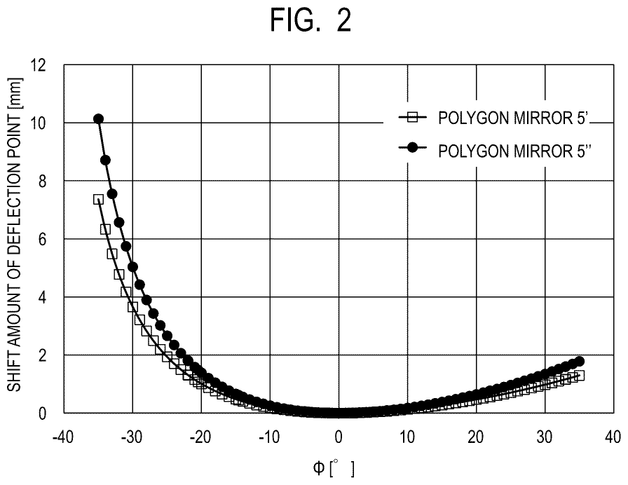

FIG. 2 shows a rotation angle φ dependence of the position in the direction parallel to the optical axis of the incident optical system 6 of the deflection point on the deflecting surface 5a with respect to the principal ray of the light flux incident on each of the polygon mirror 5′ and the polygon mirror 5″.

Specifically, FIG. 2 shows a relative position of the deflection point at each rotation angle φ with respect to the on-axis deflection point on the deflecting surface 5a with respect to the principal ray of the on-axis light flux, namely a shift amount with respect to the position of the on-axis deflection point.

As shown in FIG. 2, when the rotation angle φ is 0°, the positions in the direction parallel to the optical axis of the incident optical system 6 of the on-axis deflection points on the deflecting surface 5a with respect to the principal rays of the on-axis light fluxes incident on the polygon mirror 5′ and the polygon mirror 5″ coincide with each other.

On the other hand, when the rotation angle φ is not 0°, the positions in the direction parallel to the optical axis of the incident optical system 6 of the deflection points on the deflecting surface 5a with respect to the principal rays of the light fluxes incident on the polygon mirror 5′ and the polygon mirror 5″ do not coincide with each other.

Therefore, incident positions in the imaging optical system 7 of the light fluxes other than the on-axis light flux deflected by the deflecting surface 5a in the polygon mirror 5′ and the polygon mirror 5″, namely off-axis light fluxes are different from each other.

As a result, a field curvature occurs, so that an optical performance deteriorates.

Here, the shift amount of the deflection point on the deflecting surface 5a shown in FIG. 2 is calculated only from the inscribed circle diameter r of the polygon mirror, the shift amount “a” indicating an incident position of a light flux, and the rotation angle φ of the polygon mirror as described above, and does not depend on the number of deflecting surfaces 5a of the polygon mirror.

That is, as shown in Table 1, the polygon mirror 5′ and the polygon mirror 5 in which the numbers of deflecting surfaces 5a are different from each other but the inscribed circle diameters r are the same as each other are considered.

At this time, the positions in the direction parallel to the optical axis of the incident optical system 6 of the deflection points on the deflecting surface 5a coincide with each other at any rotation angle φ by making the shift amounts “a” equal to each other in the polygon mirror 5′ and the polygon mirror 5.

That is, when the polygon mirror 5′ and the polygon mirror 5 are arranged such that the positions of the rotation centers are the same as each other, the field curvature does not occur, so that it is possible to avoid the deterioration of the optical performance.

On the other hand, as shown in Table 1, the width in the main scanning cross section of the deflecting surface 5a is reduced in the polygon mirror 5 in which the number of deflecting surfaces 5a is increased while the inscribed circle diameter is the same as that of the polygon mirror 5′.

Therefore, in the polygon mirror 5, a part of a light flux scanning the vicinity of an outermost off-axis image height may be vignetted depending on a scanning angle, a light flux width of an incident light flux, and an incident angle in the main scanning cross section.

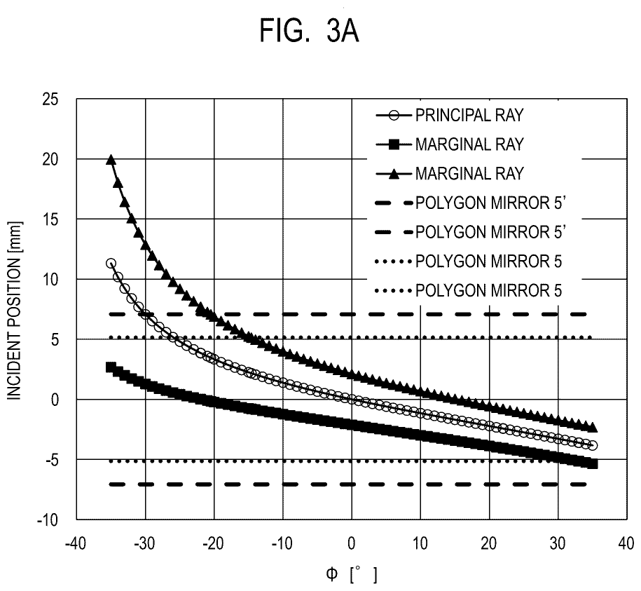

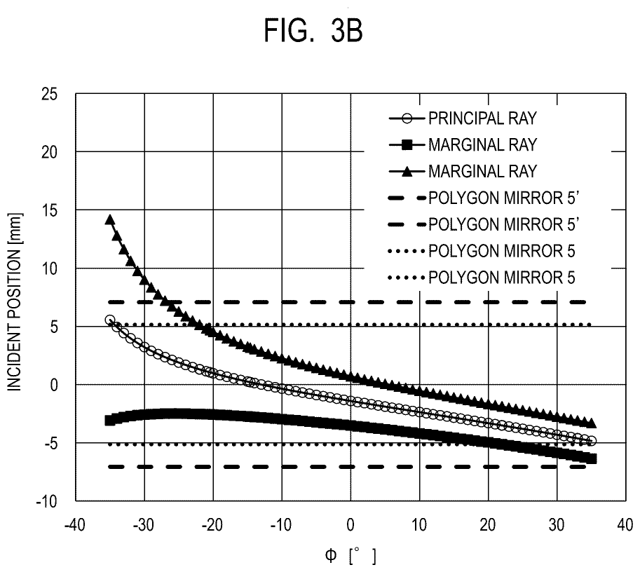

FIG. 3A shows a rotation angle φ dependence of an incident position of a principal ray and a marginal ray of a light flux incident on the polygon mirror 5′ and the polygon mirror 5.

Here, it is assumed that an angle between the optical axis of the incident optical system 6 and the optical axis of the imaging optical system 7 in the main scanning cross section is 90°, the shift amount “a” is 5 mm, and a light flux width in the main scanning direction of the incident light flux is 3 mm.

The vertical axis in FIG. 3A indicates a position of the deflection point on the deflecting surface 5a when the position of a center of the polygon mirror 5′ in the direction parallel to the optical axis of the incident optical system 6 is 0 mm at each rotation angle φ.

Broken lines of ±7.071 mm shown in FIG. 3A indicate positions of ends of the deflecting surfaces 5a of the polygon mirror 5′ in the direction parallel to the optical axis of the incident optical system 6.

Further, dotted lines of ±5.137 mm shown in FIG. 3A indicate positions of ends of the deflecting surfaces 5a of the polygon mirror 5 in the direction parallel to the optical axis of the incident optical system 6.

As shown in FIG. 3A, when the rotation angle φ becomes smaller than −20.5°, a part of the incident light flux is vignetted in the polygon mirror 5′.

On the other hand, when the rotation angle φ becomes smaller than −14.6°, a part of the incident light flux is vignetted in the polygon mirror 5.

Further, as shown in FIG. 3A, when the rotation angle φ becomes larger than +33.0°, a part of the incident light flux is vignetted in the polygon mirror 5.

On the other hand, even when the rotation angle φ increases to +35°, the incident light flux is not vignetted in the polygon mirror 5′.

Therefore, in the light scanning apparatus 50 according to the present embodiment, the shift amount “a” is changed such that the rotation angle φ on a positive side at which the light flux starts to be vignetted and the rotation angle φ on a negative side at which the light flux starts to be vignetted become the same as each other when the number of deflecting surfaces 5a is changed with maintaining a magnitude of the inscribed circle diameter r.

For example, when the shift amount “a” is changed from 5 mm to 6 mm in the polygon mirror 5′ and the polygon mirror 5, the rotation angle φ dependence of the incident positions of the principal ray and the marginal ray of the incident light flux shown in FIG. 3A changes as shown in FIG. 3B.

That is, as shown in FIG. 3B, if the rotation angle φ becomes smaller than −22° or larger than +22°, a part of the incident light flux is vignetted when the shift amount “a” is changed from 5 mm to 6 mm in the polygon mirror 5.

Therefore, when the shift amount “a” is changed from 5 mm to 6 mm in the polygon mirror 5, a region where the incident light flux is vignetted increases on the positive side of the rotation angle φ, whereas the region where the incident light flux is vignetted decreases on the negative side.

Then, convenience is improved since it is possible to use substantially the same region on both of the positive side and the negative side of the rotation angle φ.

Note that the shift amount “a” can be changed by using several methods described below.

For example, the shift amount “a” can be changed by shifting positions of the light source 1 and the incident optical system 6 in the main scanning direction or shifting a position of the rotation center of the polygon mirror 5 in a direction parallel to the optical axis of the imaging optical system 7.

The above-described method is suitable for a case where a housing for holding each optical element and the polygon mirror 5 is changed when the number of the deflecting surfaces 5a of the polygon mirror 5 is changed.

On the other hand, when a plurality of polygon mirrors 5 having different numbers of deflecting surfaces 5a are used in a single housing, it is necessary to provide a plurality of positions for holding each of the light source 1, each optical element and the polygon mirrors 5 when the above-described method is used. Therefore, a structure of the housing becomes complicated, which is not preferable.

Further, for example, a stop can be provided as a member separate from the housing to change the shift amount “a” by changing only a position of the stop.

According to this method, even when the plurality of polygon mirrors 5 having different numbers of deflecting surfaces 5a are used in the single housing, only a plurality of positions for holding the stop need to be provided, so that complication of the structure of the housing can be suppressed.

Furthermore, for example, the shift amount “a” can be changed by shifting only the position in the main scanning direction of the light source 1.

In this case, unlike the above-described method, an incident position of a light flux on the deflecting surface 5a of the polygon mirror 5 is not changed, but an incident angle of the light flux on the deflecting surface 5a of the polygon mirror 5 is changed.

Here, in the case where the stop is arranged between the light source and the collimator lens, the shift amount “a” can be changed without substantially changing the incident angle of the light flux on the deflecting surface 5a of the polygon mirror 5 when a distance between the collimator lens and the polygon mirror 5 is sufficiently large.

Further, even when the stop is arranged between the collimator lens and the polygon mirror 5, the shift amount “a” can be changed without substantially changing the incident angle of the light flux on the deflecting surface 5a of the polygon mirror 5 when a distance between the stop and the polygon mirror 5 is sufficiently large.

In particular, it can be said that this method is the optimum method among the above-described methods since the position of the light source 1 can be shifted without adding any change to the housing in the housing in which a irradiation position and a focus of the light flux can be adjusted by three-dimensionally adjusting the position of the light source 1.

Therefore, in the light scanning apparatus 50 according to the present embodiment, the shift amount “a” is changed by shifting the position in the main scanning direction of the light source 1.

That is, in the light scanning apparatus 50 according to the present embodiment, a center of a light emitting surface of the light source 1 is not on the optical axis of the incident optical system 6 when projected in the main scanning cross section.

Here, the light emitting surface of the light source 1 is a surface which is perpendicular to the optical axis of the incident optical system 6 and includes all light emitting points, and the center of the light emitting surface can be defined as a position of a single light emitting point or a center of a line segment connecting two light emitting points which are most distant from each other.

On the other hand, a shift amount of the position of the light source 1 for changing the shift amount “a” may be several times larger than a shift amount of the position of the light source 1 in the conventional three-dimensional adjustment described above.

Therefore, it is preferred that the housing of the light scanning apparatus 50 according to the present embodiment be provided such that the position of the light source 1 can be sufficiently largely shifted.

The position of the light source 1 in the housing of the light scanning apparatus 50 according to the present embodiment can be shifted, for example, by movably providing a holding member for holding the light source 1, or by changing a position at which the light source 1 is fixed to the holding member by adhesion or the like.

In the light scanning apparatus 50 according to the present embodiment, the following effects are obtained by setting the scanning angle on the positive side of the polygon mirror 5 at which the light flux starts to be vignetted and that on the negative side thereof at which the light flux starts to be vignetted so as to be the same as each other as described above.

In general, when a light flux is vignetted by the polygon mirror 5, a light amount of the light flux is reduced, so that an unevenness in light amount occurs on the surface to be scanned 9.

Such unevenness in light amount on the surface 9 can be reduced by increasing a light emission amount of the light source 1 as necessary.

At this time, there is a possibility that a timing at which the light emission amount of the light source 1 is increased is shifted when the incident position of the light flux on the polygon mirror 5 is shifted in accordance with a tolerance.

Therefore, it is preferred to correct only a light amount of a light flux for scanning the vicinity of an end of a printed region, namely the vicinity of the outermost off-axis image height where the change in the light amount, namely a correction unevenness is not conspicuous even if the timing of the correction of the light amount is shifted.

That is, when the scanning angle on the positive side of the polygon mirror 5 at which the light flux starts to be vignetted and that on the negative side thereof at which the light flux starts to be vignetted are significantly different from each other as in the related art, the light flux starts to be vignetted, so that the light amount needs to be corrected in a region away from the end of the printed region, namely the outermost off-axis image height on one side.

If the correction unevenness occurs due to the shift in the timing of the light amount correction in such region away from the end of the printed region, namely at an intermediate image height, image quality deteriorates.

Specifically, in the light scanning apparatus 50 according to the present embodiment, it is preferred that the following Inequalities (6) and (7) be satisfied:

$$Y 3 - Y 1 \leq 5. , \qquad ( 6 )$$

$$Y 4 - Y 2 \leq 5. . \qquad ( 7 )$$

In Inequality (6), Y1 represents a distance [mm] in the main scanning direction between the on-axis image height and an image height closest to the on-axis image height among image heights which light fluxes deflected so as to be vignetted by the deflecting surface 5a of the polygon mirror 5 reach, on the negative side in the main scanning direction.

In other words, Y1 represents a distance between the on-axis image height and an image height closest to the on-axis image height among at least one image height at which only a part of a light flux incident on the polygon mirror 5 is deflected by the deflecting surface 5a in the main scanning cross section and reaches on one side of the on-axis image height in the main scanning direction.

In still other words, Y1 represents a distance between the on-axis image height and an image height closest to the on-axis image height on one side of the on-axis image height among a plurality of image heights at which only a part of the light flux incident on the polygon mirror 5 reaches via the deflecting surface 5a.

Further, in Inequality (6), Y3 represents a distance [mm] in the main scanning direction between the outermost off-axis image height (second outermost off-axis image height) on the negative side in the main scanning direction and the on-axis image height.

In Inequality (7), Y2 represents a distance [mm] in the main scanning direction between the on-axis image height and an image height closest to the on-axis image height among image heights which light fluxes deflected so as to be vignetted by the deflecting surface 5a of the polygon mirror 5 reach, on a positive side in the main scanning direction.

In other words, Y2 represents a distance between the on-axis image height and an image height closest to the on-axis image height among at least one image height at which only a part of a light flux incident on the polygon mirror 5 is deflected by the deflecting surface Sa in the main scanning cross section and reaches on the other side of the on-axis image height in the main scanning direction.

In still other words, Y2 represents a distance between the on-axis image height and an image height closest to the on-axis image height on the other side of the on-axis image height among a plurality of image heights at which only a part of the light flux incident on the polygon mirror 5 reaches via the deflecting surface 5a.

Further, in Inequality (7), Y4 represents a distance [mm] in the main scanning direction between the outermost off-axis image height (first outermost off-axis image height) on the positive side in the main scanning direction and the on-axis image height.

In Inequalities (6) and (7), the on-axis image height is set as an origin of coordinates on the surface to be scanned 9, a light source side on which the light source 1 is arranged is defined as the positive side in the main scanning direction, and an opposite light source side on which the light source 1 is not arranged is defined as the negative side in the main scanning direction.

In the light scanning apparatus 50 according to the present embodiment, it is possible to sufficiently suppress a deterioration of an image quality when Inequalities (6) and (7) are satisfied and a formed unevenness in light amount, namely an unevenness in density is slight.

Further, in the light scanning apparatus 50 according to the present embodiment, it is possible to more sufficiently suppress the deterioration of the image quality when the following Inequalities (6a) and (7a) are satisfied and the formed unevenness in light amount, namely the unevenness in density is slight:

$$Y 3 - Y 1 \leq 3. , \qquad ( 6 a )$$

$$Y 4 - Y 2 \leq 3. . \qquad ( 7 a )$$

Accordingly, it is sufficient to examine whether or not at least Inequalities (6) and (7) are satisfied when the number of deflecting surfaces 5a is increased with maintaining the inscribed circle diameter as in the case of the polygon mirror 5 as compared with the polygon mirror 5′, for example.

Specifically, in the light scanning apparatus 50 according to the present embodiment, scanning angles by the polygon mirror 5 when scanning image heights of ±108.00 mm which are the outermost off-axis image heights are ±23.089° since an fθ coefficient of the imaging optical system 7 is 134 mm/radian.

On the other hand, a width in the main scanning cross section of the deflecting surface 5a of the polygon mirror 5 is as small as 10.275 mm as described above.

Therefore, in the case where a position of the light source 1 is not shifted, a part of a light flux is vignetted when the light flux reaching a region between an image height of −94.36 mm and the outermost off-axis image height of −108.00 mm on the negative side in the main scanning direction on the surface to be scanned 9 is deflected by the deflecting surface 5a of the polygon mirror 5.

As a result, when the light flux reaching the outermost off-axis image height of −108.00 mm is deflected by the deflecting surface 5a of the polygon mirror 5, 13.3% of the incident light flux is vignetted, so that a decrease in light amount occurs.

Therefore, in the light scanning apparatus 50 according to the present embodiment, the light source 1 is arranged so as to be shifted by 0.278 mm in an orientation away from the surface 9 in a direction perpendicular to the optical axis of the incident optical system 6.

Thereby, a part of a light flux is vignetted when the light flux reaching a region between an image height of 105.02 mm and the outermost off-axis image height of 108.00 mm on the positive side in the main scanning direction on the surface 9 is deflected by the deflecting surface 5a of the polygon mirror 5.

Further, a part of a light flux is vignetted when the light flux reaching a region between an image height of −105.04 mm and the outermost off-axis image height of −108.00 mm on the negative side in the main scanning direction on the surface 9 is deflected by the deflecting surface 5a of the polygon mirror 5.

As a result, when the light flux reaching the outermost off-axis image height of 108.00 mm is deflected by the deflecting surface 5a of the polygon mirror 5, 1.8% of the incident light flux is vignetted, so that the light amount is reduced.

Further, when the light flux reaching the outermost off-axis image height of −108.00 mm is deflected by the deflecting surface 5a of the polygon mirror 5, 2.8% of the incident light flux is vignetted, so that the light amount is reduced.

That is, in the light scanning apparatus 50 according to the present embodiment, Inequalities (6), (6a), (7) and (7a) are satisfied since Y1=105.04, Y2=105.02, Y3=108.00 and Y4=108.00.

Thereby, it is possible to make the regions which the partially vignetted light fluxes reach on the positive side and the negative side in the main scanning direction on the surface 9, substantially the same as each other.

Then, it is possible to reduce a ratio at which the light flux reaching the outermost off-axis image height of −108.00 mm is vignetted when deflected by the deflecting surface 5a of the polygon mirror 5 from 13.3% to 2.8%.

Further, in the light scanning apparatus 50 according to the present embodiment, it is possible to sufficiently reduce the region which the partially vignetted light fluxes reach on each of the positive side and the negative side in the main scanning direction on the surface 9 to 5 mm or less since Y3−Y1=2.96 mm and Y4−Y2=2.98 mm.

As a result, even when the unevenness in density caused by the vignetting or an image streak caused by the deviation of the correction timing when the light amount is corrected occur, they are not conspicuous, so that it is possible to suppress the deterioration of the image quality.

When the housing is formed such that the light source 1, each optical element and the polygon mirror 5 are movable, positions of screw holes for fixing them may be too close to each other, or a movable region of the light source 1 may be limited.

In this case, it is difficult to make the scanning angle on the positive side of the polygon mirror 5 at which the light flux starts to be vignetted and that on the negative side thereof at which the light flux starts to be vignetted exactly equal to each other.

In such case, even if the scanning angle on the positive side of the polygon mirror 5 at which the light flux starts to be vignetted and that on the negative side thereof at which the light flux starts to be vignetted are not exactly the same as each other, a sufficient effect can be obtained if they are the same as each other to some extent.

Specifically, the effect of the present embodiment can be sufficiently obtained when the following Inequality (8) is satisfied:

$$- 0.005 \leq \frac{Y 2 - Y 1}{Y 2 + Y 1} \leq 0.005 . \qquad ( 8 )$$

If the ratio exceeds the upper limit value or falls below the lower limit value in Inequality (8), it becomes difficult to sufficiently reduce the ratios of light fluxes reaching the outermost off-axis image heights of 108.00 mm and −108.00 mm that are vignetted when deflected by the deflecting surface Sa of the polygon mirror 5.

In addition, the unevenness in density is likely to be conspicuous when the light amount is not corrected, so that the image quality deteriorates since the region where the partially vignetted light flux reaches becomes wider toward the on-axis image height on one side in the main scanning direction on the surface to be scanned 9.

Further, even in a case where the light amount is corrected, the image streak generated when the correction timing is shifted is likely to be visually recognized in a central portion of a scanned region, so that the image quality deteriorates.

In the light scanning apparatus 50 according to the present embodiment, it is preferred that the following Inequality (8a) be satisfied instead of Inequality (8):

$$- 0.003 \leq \frac{Y 2 - Y 1}{Y 2 + Y 1} \leq 0.003 . \qquad ( 8 a )$$

Further, in the light scanning apparatus 50 according to the present embodiment, it is more preferred that the following Inequality (8b) be satisfied instead of Inequality (8a):

$$- 0.002 \leq \frac{Y 2 - Y 1}{Y 2 + Y 1} \leq 0.002 . \qquad ( 8 b )$$

In the light scanning apparatus 50 according to the embodiment, Inequalities (8), (8a) and (8b) are satisfied since Y1=105.04 and Y2=105.02.

When the light flux is shifted in the main scanning direction by shifting the light source 1 in the main scanning direction as described above, it is preferred to shift the light source 1 so as to be away from the surface to be scanned 9.

In other words, in the light scanning apparatus 50 according to the present embodiment, it is preferred to shift the position of the light source 1 such that the center of the light emitting surface of the light source 1 is arranged on an opposite side of the surface 9 with respect to a cross section including the optical axis of the incident optical system 6 and parallel to the sub-scanning direction.

This is because a light flux for scanning an image height in the region where the rotation angle φ is negative, namely on the side opposite to the light source is more likely to be vignetted as compared with that for scanning an image height in the region where the rotation angle φ is positive, namely on the same side as the light source, as shown in FIGS. 3A and 3B.

At this time, the light flux for scanning the image height on the side opposite to the light source is hardly vignetted when the light flux is made incident on the polygon mirror 5 so as to be away from the rotation center of the polygon mirror 5.

This can also be understood from the fact that the region where the light flux is not vignetted increases in the region where the rotation angle φ is negative by changing the shift amount “a” from 5 mm to 6 mm in the polygon mirror 5 as shown in FIGS. 3A and 3B.

Then, the light flux incident on the anamorphic collimator lens 3 from the light source 1 is emitted from the anamorphic collimator lens 3 in a direction relatively closer to the surface to be scanned 9 when only the arrangement position of the light source 1 is shifted so as to be away from the surface 9.

As a result, the light flux emitted from the anamorphic collimator lens 3 can be incident on the polygon mirror 5 at a position relatively away from the rotation center.

On the other hand, the position at which the light flux deflected by the polygon mirror 5 is incident on the imaging optical system 7 is also shifted when the arrangement position of the light source 1 is shifted as described above.

Further, a scanning line is curved on the surface 9 when the deflecting surface 5a of the polygon mirror 5 is tilted in the sub-scanning direction.

That is, a function of the facet angle error compensation is deteriorated in the light scanning apparatus 50 according to the present embodiment.

When the function of the facet angle error compensation is sufficient, coordinates in the sub-scanning direction of irradiating positions of the light fluxes at the outermost off-axis image heights on the positive side and the negative side in the main scanning direction on the surface 9 are substantially the same as each other, and are also substantially the same as an coordinate in the sub-scanning direction of an irradiating position of the light flux at the on-axis image height.

In general, such curvature of the scanning line is reduced by making the irradiating position in the sub-scanning direction of the light flux at the outermost off-axis image height corresponding to the largest scanning angle on the positive side and that at the outermost off-axis image height corresponding to the largest scanning angle on the negative side the same as each other.

On the other hand, when the shift amount of the incident position of the light flux on the polygon mirror 5 as described above is increased, the irradiating positions in the sub-scanning direction of the light fluxes at the outermost off-axis image heights on both sides are significantly different from each other, so that the curvature of the scanning line is notably increased.

Therefore, in the light scanning apparatus 50 according to the present embodiment, it is preferred that the following Inequality (9) be satisfied when a normal of the deflecting surface 5a of the polygon mirror 5 is tilted by an angle of 2′ with respect to the main scanning cross section in a cross section including the normal and parallel to the sub-scanning direction:

$$0.3 \leq \frac{Z 3 + Z 4}{Z 0 + Max ( Z 3 , Z 4 )} \leq 0.82 . \qquad ( 9 )$$

In Inequality (9), Z3 represents a distance in the sub-scanning direction between the optical axis of the imaging optical system 7 and a reaching position of the light flux at the outermost off-axis image height on the negative side in the main scanning direction.

Further, in Inequality (9), Z4 represents a distance in the sub-scanning direction between the optical axis of the imaging optical system 7 and a reaching position of the light flux at the outermost off-axis image height on the positive side in the main scanning direction.

Furthermore, in Inequality (9), Z0 represents a distance in the sub-scanning direction between the optical axis of the imaging optical system 7 and the reaching position that is most distant in the sub-scanning direction from the reaching position at one of the outermost off-axis image heights corresponding to the larger value of Z3 and Z4 among reaching positions of the deflected light fluxes at the respective image heights.

In addition, in Inequality (9), Max (Z3, Z4) represents the larger value of Z3 and Z4.

If the ratio exceeds the upper limit value in Inequality (9), an amount of curvature of the scanning line becomes too large, so that intervals between the scanning lines become sparse and dense according to the image height, thereby the unevenness in density becomes conspicuous.

On the other hand, if the ratio falls below the lower limit value in Inequality (9), the scanning angle on the positive side of the polygon mirror 5 at which the light flux starts to be vignetted and that on the negative side thereof at which the light flux starts to be vignetted are not the same as each other since the shift of the incident position of the light flux on the polygon mirror 5 is not sufficient. As a result, the light flux starts to be vignetted in a region away from the end of the printed region, namely at an intermediate image height, and correction unevenness is conspicuous when the timing of the correction of the light amount is shifted, so that the image quality is deteriorated.

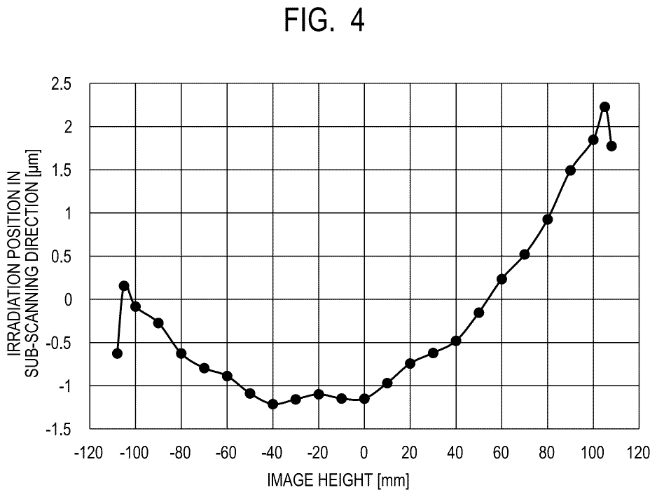

FIG. 4 shows the scanning line formed on the surface to be scanned 9 when the normal of the deflecting surface 5a of the polygon mirror 5 is tilted by the angle of 2′ with respect to the main scanning cross section in the cross section including the normal and parallel to the sub-scanning direction in the light scanning apparatus 50 according to the present embodiment.

Specifically, the vertical axis of FIG. 4 indicates the coordinate in the sub-scanning direction of the reaching position of the light flux on the surface 9, and the horizontal axis of FIG. 4 indicates the image height.

As shown in FIGS. 4, Z3=−0.63 μm, Z4=1.77 μm, and Z0=−1.21 μm (at the image height of −40 mm), so that Inequality (9) is satisfied in the light scanning apparatus 50 according to the present embodiment.

In the above description, a method of increasing the number of deflecting surfaces 5a of the polygon mirror 5 in the light scanning apparatus 50 in which a light source having a single light emitting point is used as the light source 1 has been described.

Next, a method of increasing the number of deflecting surfaces of a polygon mirror in a light scanning apparatus in which a light source having a plurality of light emitting points is used as the light source 1 is considered.

First, a case is considered in which the plurality of light emitting points are arranged optically at the same position in the main scanning cross section, but are arranged away from each other, for example, away from each other at equal intervals in the sub-scanning direction.

In this case, the plurality of light fluxes emitted from the respective light emitting points travel on the same optical path in the main scanning cross section, so that the above-described structure in which the light source having the single light emitting point is used can be similarly applied.

On the other hand, in the case where the plurality of light emitting points are optically arranged at positions different from each other in the main scanning cross section, the positions of the respective light fluxes in the main scanning cross section when they are incident on the polygon mirror 5 are different from each other.

Therefore, a light flux which is vignetted by the deflecting surface 5a of the polygon mirror 5 and that which is not vignetted are included in the plurality of light fluxes from the plurality of light emitting points that reach the same predetermined image height.

In this case, the image heights closest to the on-axis image height among the image heights which the light fluxes deflected to be vignetted by the deflecting surfaces 5a of the polygon mirror 5 reach may coincide with each other between the positive side and the negative side in the main scanning direction for the respective light fluxes.

In other words, the minimum value of the distances Y1 and that of the distances Y2 may coincide with each other in the respective light fluxes.

Thereby, the image height at which the light amount is corrected can be brought as close to the end of the scanned region as possible, so that it is possible to suppress the deterioration in image quality due to correction unevenness.

Further, a light flux which is vignetted at each image height in a wide region on the positive side in the main scanning direction is vignetted only at each image height in a narrow region on the negative side in the main scanning direction.

On the other hand, a light flux which is vignetted at each image height in a wide region on the negative side in the main scanning direction is vignetted only at each image height in a narrow region on the positive side in the main scanning direction.

Therefore, it is sufficient that a predetermined light flux which is not vignetted by the deflecting surface Sa of the polygon mirror 5 among the light fluxes reaching the outermost off-axis image height on the positive side in the main scanning direction is vignetted by the deflecting surface 5a of the polygon mirror 5 when reaching the outermost off-axis image height on the negative side in the main scanning direction.

Thereby, a balance of the image height for which the light flux starts to be vignetted by the deflecting surfaces 5a of the polygon mirror 5 between the positive side and the negative side in the main scanning direction can be easily achieved, so that the deterioration of the image quality due to the correction unevenness can be suppressed.

Further, a light flux width of the light flux incident on the polygon mirror 5 when projected onto the deflecting surface 5a is larger when it scans the image height on the negative side in the main scanning direction than when it scans the image height on the positive side in the main scanning direction.

Therefore, the light flux reaching the image height on the positive side in the main scanning direction is more likely to be vignetted by the deflecting surface 5a of the polygon mirror 5 than that reaching the image height on the negative side in the main scanning direction.

On the other hand, the light flux reaching the image height on the negative side in the main scanning direction has a large light flux width when projected onto the deflecting surface 5a as described above, so that an influence of the vignetting is small.

Therefore, in the light scanning apparatus 50 according to the present embodiment, it is preferred that the following Inequality (10) be satisfied:

$$1 \leq n 1 \leq n 2. \qquad ( 10 )$$

In Inequality (10), n1 represents the number of light fluxes reaching the outermost off-axis image height on the positive side in the main scanning direction by being deflected while being vignetted by the deflecting surface 5a of the polygon mirror 5.

Further, in Inequality (10), n2 represents the number of light fluxes reaching the outermost off-axis image height on the negative side in the main scanning direction by being deflected while being vignetted by the deflecting surface 5a of the polygon mirror 5.

If n2<n1 is satisfied unlike Inequality (10), a decrease in light amount at the outermost off-axis image height on the positive side in the main scanning direction is larger than the decrease in light amount at the outermost off-axis image height on the negative side in the main scanning direction. Therefore, it is necessary to increase a correction amount of the light amount.

Further, if n1<1 is satisfied unlike Inequality (10), any light flux reaching the outermost off-axis image height on the positive side in the main scanning direction is not vignetted when deflected by the deflecting surface 5a of the polygon mirror 5, so that the decrease in the light amount on the surface to be scanned becomes unbalanced.

In the light scanning apparatus 50 according to the present embodiment, Inequality (10) is satisfied since n1=1 and n2=1.

In the light scanning apparatus 50 according to the present embodiment, it is preferred that the following Inequality (11) be satisfied:

$$\frac{( \frac{720}{N} )}{N - 1} + 45 < θ < \frac{( \frac{720}{N} )}{N - 1} + 60. \qquad ( 11 )$$

In Inequality (11), N represents the number of deflecting surfaces 5a of the polygon mirror 5, and θ represents an angle [°] in the main scanning cross section between the optical axis of the incident optical system 6 and the optical axis of the imaging optical system 7.

If the value is equal to or larger than the upper limit value in Inequality (11), the light flux incident on the polygon mirror 5 is easily vignetted, so that the light flux starts to be vignetted in a region away from the end of the printed region, namely at an intermediate image height.

On the other hand, if the value is equal to or smaller than the lower limit value in Inequality (11), the incident optical system 6 and a beam detection (BD) optical system (not shown) are too close to each other, so that it becomes difficult to arrange both of the optical systems.

In the light scanning apparatus 50 according to the present embodiment, Inequality (11) is satisfied since θ=87.5° and N=5.

In the light scanning apparatus 50 according to the present embodiment, it is preferred that the following Inequality (12) be satisfied:

$$0.30 \leq \frac{L}{W} \leq 0.7 . \qquad ( 12 )$$

In Inequality (12), L represents a distance [mm] on the optical axis of the incident optical system 6 between the light emitting surface of the light source 1 and the on-axis deflection point on the deflecting surface 5a of the polygon mirror 5, and W represents a distance between both of the outermost off-axis image heights on the surface to be scanned 9, namely corresponds to Y3+Y4.

If the ratio exceeds the upper limit value in Inequality (12), the size of the light scanning apparatus 50 according to the present embodiment is increased along with an increase in the size of the incident optical system 6, so that it becomes difficult to secure a space for mounting the light scanning apparatus 50 according to the present embodiment in an image forming apparatus.

On the other hand, if the ratio falls below the lower limit value in Inequality (12), it becomes difficult to sufficiently shift the light flux in the main scanning direction even if the light source 1 is shifted in the main scanning direction as described above.

In the light scanning apparatus 50 according to the present embodiment, Inequality (12) is satisfied since L=84.4, Y3=108.00 and Y4=108.00.

As described above, the light source 1 is arranged so as to be shifted by 0.278 mm in the orientation away from the surface to be scanned 9 in the direction perpendicular to the optical axis of the incident optical system 6 in the light scanning apparatus 50 according to the present embodiment.

This is larger than a shift of the light source 1 of about several tens of μm in a normal adjustment of the reaching position of each light flux on the surface 9.

In order to largely shift the light source 1 as described above in the light scanning apparatus 50 according to the present embodiment, a holding member for holding the light source 1 may be provided so as to be movable in the housing, for example.

Further, the light source 1 may be adhered to be fixed in consideration of the shift position described above in the light scanning apparatus 50 according to the present embodiment.

When the polygon mirror 5 having a small width in the main scanning cross section of deflecting surface 5a is used as in the light scanning apparatus 50 according to the present embodiment, the light source 1 is required to be shifted by a shift amount larger than that in the normal adjustment by about one digit.

On the other hand, the polygon mirror 5′ having four deflecting surfaces 5a can also be used since a structure in which the light source 1 can be shifted by such large shift amount is provided in the light scanning apparatus 50 according to the present embodiment.

When only the polygon mirror 5 having five deflecting surfaces 5a is used in the light scanning apparatus 50 according to the present embodiment, a region in which the light source 1 can be arranged may be provided so as to be shifted in consideration of the above-described shift amount.

As described above, in the light scanning apparatus 50 according to the present embodiment, it is possible to suppress deterioration in image quality due to an unevenness in density generated on the surface to be scanned 9 by performing an adjustment such that a light flux is appropriately vignetted by the small polygon mirror 5 so as to satisfy Inequality (8).

### Second Embodiment

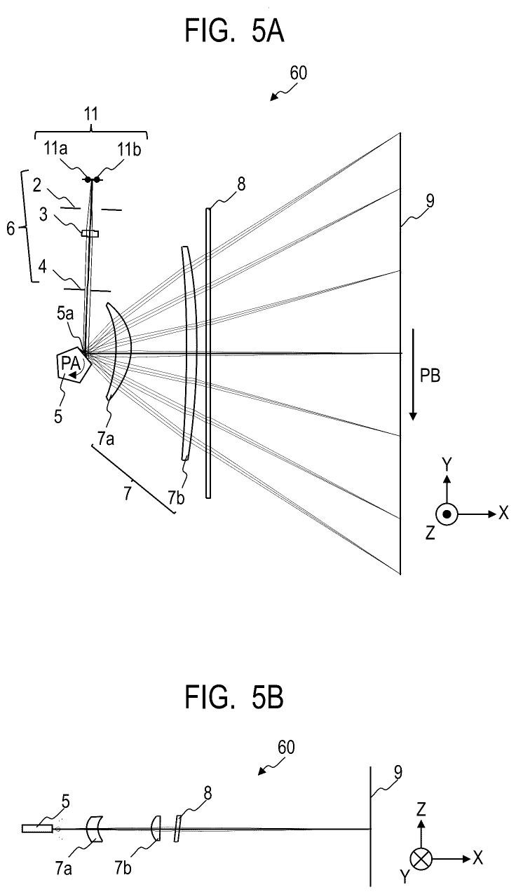

FIGS. 5A and 5B show a schematic main scanning cross sectional view and a partial schematic sub-scanning cross sectional view of a light scanning apparatus 60 according to a second embodiment of the present disclosure, respectively.

Since the light scanning apparatus 60 according to the present embodiment has the same structure as the light scanning apparatus 50 according to the first embodiment except that a light source 11 is provided instead of the light source 1, the same members are denoted by the same reference numerals, and the description thereof is omitted.

Specifically, the light source 11 provided in the light scanning apparatus 60 according to the present embodiment has two light emitting points.

The two light emitting points are arranged so as to be separated from each other by 90 μm on a straight line in a direction rotated counterclockwise by 5.4° with respect to the main scanning cross section when viewed from the polygon mirror 5 side in a direction parallel to the optical axis of the incident optical system 6.

Thereby, an interval between scanning lines formed on the surface to be scanned 9 by the two light emitting points can be made uniform.

Then, a shift amount of the light source 11 in an orientation away from the surface 9 in a direction perpendicular to the optical axis of the incident optical system 6 is changed to 0.26 mm as compared with the light scanning apparatus 50 according to the first embodiment, in accordance with the arrangement of the two light emitting points.

Further, a width in the main scanning direction of the rectangular aperture formed in the main scanning stop 4 is set to 2.8 mm, which is slightly smaller than that of the light scanning apparatus 50 according to the first embodiment, in the light scanning apparatus 60 according to the present embodiment.

In the light scanning apparatus 60 according to the present embodiment, two light fluxes emitted from the two light emitting points of the light source 11 pass through the shared sub-scanning stop 2 and the shared main scanning stop 4.

Therefore, incident positions of the two light fluxes on the polygon mirror 5 are different from each other in the main scanning direction.

Next, numerical values such as curvature radii in the main scanning cross section and the sub-scanning cross section, a surface interval, and a refractive index of each optical element provided in the light scanning apparatus 60 according to the present embodiment are shown in the following Table 6.

TABLE 6

| | | | | n |
|---|---|---|---|---|
| | RY [mm] | RZ [mm] | D [mm] | (λ = 792 nm) |
| Light source 11 | | | 0.50 | |
| Incident surface of cover glass | ∞ | | 0.25 | 1.5105 |
| Exit surface of cover glass | ∞ | | 13.65 | |
| Sub-scanning stop 2 | ∞ | | 10.40 | |
| Incident surface of anamorphic collimator lens 3 | ∞ (diffracting surface) | | 3.00 | 1.5282 |
| Exit surface of anamorphic collimator lens 3 | −32.381 | −18.751 | 25.90 | |
| Main scanning stop 4 | ∞ | | 30.70 | |
| Deflecting surface 5a of polygon mirror 5 | ∞ | | 16.00 | |
| Incident surface of first imaging lens 7a | −34.420 | 13.000 | 6.70 | 1.5282 |
| Exit surface of first imaging lens 7a | −21.765 | 13.000 | 26.37 | |
| Incident surface of second imaging lens 7b | −800.000 | 20.100 | 3.50 | 1.5282 |
| Exit surface of second imaging lens 7b | 139.423 | −78.397 | 6.67 | |
| Incident surface of dustproof glass 8 | ∞ | | 1.83 | 1.5105 |
| Exit surface of dustproof glass 8 | ∞ | | 92.78 | |
| Surface to be scanned 9 | | | | |

Aspherical coefficients of the incident surface and the exit surface of each of the first imaging lens 7a and the second imaging lens 7b provided in the light scanning apparatus 60 according to the present embodiment are shown in the following Table 7.

TABLE 7

| Aspherical | Incident surface | Exit surface of | Incident surface | Exit surface of |
|---|---|---|---|---|
| surface | of first imaging | first imaging | of second | second imaging |
| coefficient | lens 7a | lens 7a | imaging lens 7b | lens 7b |
| RY | −3.442E+01 | −2.176E+01 | −8.000E+02 | 1.394E+02 |
| ku | −1.669E−04 | −1.179E+00 | 0 | −6.894E+01 |
| B3 | 0 | 0 | 0 | −1.194E−07 |
| B4 | 8.682E−06 | 1.618E−06 | 0 | −2.313E−06 |
| B5 | 0 | 0 | 0 | 3.651E−11 |
| B6 | 2.298E−08 | 1.062E−09 | 0 | 1.118E−09 |
| B7 | 0 | 0 | 0 | 3.002E−15 |
| B8 | −4.937E−11 | 4.350E−11 | 0 | −4.272E−13 |
| B9 | 0 | 0 | 0 | −1.074E−17 |
| B10 | 2.430E−15 | −8.671E−14 | 0 | 1.017E−16 |
| B11 | 0 | 0 | 0 | 3.012E−21 |
| B12 | 0 | 0 | 0 | −1.086E−20 |
| Rz | 1.300E+01 | 1.300E+01 | 2.010E+01 | −7.840E+01 |
| D1 | 0 | 0 | −3.629E−03 | 1.208E−02 |
| D2 | 0 | −6.263E−04 | 6.127E−04 | −2.598E−04 |
| D3 | 0 | 0 | −2.506E−06 | −1.744E−05 |
| D4 | 0 | 6.079E−06 | 7.052E−08 | −1.302E−08 |
| D5 | 0 | 0 | 2.136E−09 | 1.457E−08 |
| D6 | 0 | −2.342E−08 | −1.620E−10 | 2.381E−10 |
| D7 | 0 | 0 | 1.056E−12 | −7.480E−12 |
| D8 | 0 | 4.329E−11 | 1.380E−14 | −1.649E−13 |
| D9 | 0 | 0 | −1.462E−15 | 2.155E−15 |
| D10 | 0 | −2.525E−14 | 5.373E−17 | 3.792E−17 |
| D11 | 0 | 0 | 3.127E−19 | −2.450E−19 |
| D12 | 0 | 0 | −1.683E−20 | −1.686E−21 |
| M0_1 | 0 | 0 | 1.222E−01 | 1.250E−01 |
| M1_1 | 0 | 0 | −2.554E−05 | −2.026E−06 |
| M2_1 | 5.904E−04 | 5.636E−04 | 9.684E−05 | 4.238E−05 |
| M3_1 | 0 | 0 | 2.570E−08 | 6.133E−08 |
| M4_1 | −3.626E−06 | −1.141E−06 | −1.759E−07 | −6.762E−08 |
| M5_1 | 0 | 0 | −1.998E−11 | −1.011E−10 |
| M6_1 | 6.318E−09 | −4.677E−09 | 1.034E−10 | 2.828E−11 |
| M7_1 | 0 | 0 | 2.553E−14 | 7.097E−14 |
| M8_1 | −6.274E−12 | 9.288E−12 | −2.966E−14 | −5.017E−15 |
| M9_1 | 0 | 0 | −1.233E−17 | −1.924E−17 |
| M10_1 | 1.001E−14 | 0 | 3.260E−18 | 4.072E−20 |
| M0_4 | 0 | 0 | 0 | −1.377E−04 |
| M1_4 | 0 | 0 | 0 | 5.070E−06 |
| M2_4 | 0 | 0 | 0 | 2.746E−07 |
| M3_4 | 0 | 0 | 0 | −3.784E−09 |
| M4_4 | 0 | 0 | 0 | −1.484E−10 |
| M5_4 | 0 | 0 | 0 | 8.911E−13 |
| M6_4 | 0 | 0 | 0 | 3.737E−14 |

Aspherical shapes of the incident surface and the exit surface of each of the first imaging lens 7a and the second imaging lens 7b provided in the light scanning apparatus 60 according to the present embodiment are expressed by Expressions (1) to (3) described above.

Further, the phase function φ of the diffracting surface formed on the incident surface of the anamorphic collimator lens 3 provided in the light scanning apparatus 60 according to the present embodiment is expressed by Expression (4) described above, and the phase coefficients C and E are shown in the following Table 8.

TABLE 8

| Phase | Incident surface of |
|---|---|
| coefficient | anamorphic collimator lens 3 |
| C | −1.197E−02 |
| E | −1.489E−02 |

A coordinate of the surface vertex and an angle of the surface normal of each optical surface in the light scanning apparatus 60 according to the present embodiment are shown in the following Table 9.

TABLE 9

| | | | | Angle of normal | Angle of normal |
|---|---|---|---|---|---|
| | X coordinate | Y coordinate | Z coordinate | in main scanning | in sub-scanning |
| | [mm] | [mm] | [mm] | cross section [°] | cross section [°] |
| Light source 11 | 3.422 | 84.331 | 0 | −92.5 | 0 |
| Sub-scanning | 3.053 | 69.933 | 0 | −92.5 | 0 |
| stop 2 | | | | | |
| Incident surface | 2.600 | 59.543 | 0 | −92.5 | 0 |
| of anamorphic | | | | | |
| collimator lens 3 | | | | | |
| Main scanning | 1.524 | 34.912 | 0 | −92.5 | 0 |
| stop 4 | | | | | |
| Rotation axis of | −5.747 | −4.222 | 0 | | |
| polygon mirror 5 | | | | | |
| Incident surface | 16.000 | 0 | 0 | 0 | 0 |
| of first imaging | | | | | |
| lens 7a | | | | | |
| Incident surface | 49.073 | 0 | 0 | 0 | 0 |
| of second | | | | | |
| imaging lens 7b | | | | | |
| Incident surface | 59.246 | 0 | 0 | 0 | −9.53 |
| of dustproof | | | | | |
| glass 8 | | | | | |
| Surface to be | 153.848 | 0 | 0 | 0 | 0 |
| scanned 9 | | | | | |

With respect to the angles of the surface normals of the first imaging lens 7a and the second imaging lens 7b shown in Table 9, the aspherical shapes defined by the aspherical coefficients shown in Table 7 are not considered.

Further, with respect to the position of the light source 11 shown in Table 9, it is considered that the light source 11 is arranged so as to be shifted by 0.26 mm in an orientation away from the surface to be scanned 9 in a direction perpendicular to the optical axis of the incident optical system 6.

Furthermore, the position of the light source 11 shown in Table 9 is shown as a middle point between the positions of the two light emitting points.

Here, of the two light emitting points of the light source 11, one light emitting point that is more distant from the surface 9 in the direction perpendicular to the optical axis of the incident optical system 6 is referred to as a first light emitting point 11a, and the other light emitting point is referred to as a second light emitting point 11b.

A light flux emitted from the first light emitting point 11a is referred to as a first light flux, and a light flux emitted from the second light emitting point 11b is referred to as a second light flux.

In the light scanning apparatus 60 according to the present embodiment, the scanning angles by the polygon mirror 5 when scanning image heights of ±108.00 mm, which are the outermost off-axis image heights, are ±23.089° since the fθ coefficient of the imaging optical system 7 is 134 mm/radian.

On the other hand, the width in the main scanning cross section of the deflecting surface 5a of the polygon mirror 5 is as small as 10.275 mm.

Therefore, in the case where the position of the light source 11 is not shifted, a part of the first light flux is vignetted when the first light flux that reaches a region between an image height of −99.03 mm and the outermost off-axis image height of −108.00 mm on the negative side in the main scanning direction on the surface to be scanned 9 is deflected by the deflecting surface 5a.

Further, in the case where the position of the light source 11 is not shifted, a part of the second light flux is vignetted when the second light flux which reaches a region between an image height of −95.14 mm and the outermost off-axis image height of −108.00 mm on the negative side in the main scanning direction on the surface 9 is deflected by the deflecting surface 5a.

That is, when scanning the outermost off-axis image height of −108.00 mm on the negative side in the main scanning direction on the surface 9, the second light flux is more vignetted than the first light flux when they are deflected by the deflecting surface 5a.

Specifically, when the second light flux reaching the outermost off-axis image height of −108.00 mm is deflected by the deflecting surface 5a of the polygon mirror 5, 13.2% of the incident light flux is vignetted, so that the light amount is reduced.

Therefore, in the light scanning apparatus 60 according to the present embodiment, the light source 11 is arranged so as to be shifted by 0.26 mm in the orientation away from the surface 9 in the direction perpendicular to the optical axis of the incident optical system 6.

Thereby, the first light flux reaching any of the image heights on the negative side in the main scanning direction on the surface 9 is not vignetted when deflected by the deflecting surface 5a.

On the other hand, a part of the first light flux is vignetted when the first light flux reaching a region between an image height of 106.07 mm and the outermost off-axis image height of 108.00 mm on the positive side in the main scanning direction on the surface 9 is deflected by the deflecting surface 5a.

Further, the second light flux reaching any of the image heights on the positive side in the main scanning direction on the surface 9 is not vignetted when deflected by the deflecting surface 5a.

On the other hand, a part of the second light flux is vignetted when the second light flux reaching a region between an image height of −106.55 mm and the outermost off-axis image height of −108.00 mm on the negative side in the main scanning direction on the surface 9 is deflected by the deflecting surface 5a.

In other words, in the light scanning apparatus 60 according to the present embodiment, only a part of the first light flux incident on the polygon mirror 5 is deflected by the deflecting surface 5a when the normal of the deflecting surface 5a forms a predetermined angle (first angle) with respect to the optical axis of the imaging optical system 7 in the main scanning cross section. Then, the deflected part of the first light flux reaches a first outermost off-axis image height on one side.

On the other hand, all of the second light flux incident on the polygon mirror 5 is deflected by the deflecting surface 5a and reaches the first outermost off-axis image height when the deflecting surface 5a is at the predetermined angle in the main scanning cross section.

Further, all of the first light flux incident on the polygon mirror 5 is deflected by the deflecting surface 5a and reaches the second outermost off-axis image height on the other side when the normal of the deflecting surface 5a forms another predetermined angle (second angle) with respect to the optical axis of the imaging optical system 7 in the main scanning cross section.

On the other hand, only a part of the second light flux incident on the polygon mirror 5 is deflected by the deflecting surface 5a and reaches the second outermost off-axis image height when the deflecting surface 5a is at the another predetermined angle in the main scanning cross section.

As a result, when the first light flux reaching the outermost off-axis image height of 108.00 mm is deflected by the deflecting surface 5a of the polygon mirror 5, 1.2% of the incident light flux is vignetted, so that the light amount is reduced.

Further, when the second light flux reaching the outermost off-axis image height of −108.00 mm is deflected by the deflecting surface 5a of the polygon mirror 5, 1.5% of the incident light flux is vignetted, so that the light amount is reduced.

Thereby, the region where the partially vignetted first light flux reaches on the positive side in the main scanning direction on the surface to be scanned 9 and that where the partially vignetted second light flux reaches on the negative side in the main scanning direction on the surface 9 can be made substantially the same as each other.

Then, the percentage of the first light flux reaching the outermost off-axis image height of 108.00 mm and that of the second light flux reaching the outermost off-axis image height of −108.00 mm that are vignetted when deflected by the deflecting surface 5a of the polygon mirror 5 can be reduced to 1.2% and 1.5%, respectively.

In the light scanning apparatus 60 according to the present embodiment, it is preferred that the above-described Inequalities (6) and (7) be satisfied, and it is more preferred that the above-described Inequalities (6a) and (7a) be satisfied.

Y1 is defined as a distance [mm] in the main scanning direction between the on-axis image height and an image height closest to the on-axis image height among image heights which the first and second light fluxes deflected to be vignetted by the deflecting surface 5a of the polygon mirror 5 reach on the negative side in the main scanning direction.

Y2 is defined as a distance [mm] in the main scanning direction between an on-axis image height and an image height closest to the on-axis image height among image heights which the first and second light fluxes deflected to be vignetted by the deflecting surface 5a of the polygon mirror 5 reach on the positive side in the main scanning direction.

That is, in the light scanning apparatus 60 according to the present embodiment, Inequalities (6), (6a), (7) and (7a) are satisfied since Y1=106.55, Y2=106.07, Y3=108.00 and Y4=108.00.

Accordingly, it is possible to sufficiently reduce the region which the partially vignetted light fluxes reach, to 5 mm or less on each of the positive side and the negative side in the main scanning direction on the surface to be scanned 9.

As a result, even when an unevenness in density caused by the vignetting or an image streak caused by a deviation of a correction timing when the light amount is corrected is generated, they are not conspicuous, so that it is possible to suppress a deterioration of an image quality.

Further, in the light scanning apparatus 60 according to the present embodiment, the above-described Inequality (8) is satisfied, it is preferred that the above-described Inequality (8a) be satisfied, and it is more preferred that the above-described Inequality (8b) be satisfied.

In the light scanning apparatus 60 according to the present embodiment, Inequalities (8), (8a) and (8b) are satisfied since Y1=106.55 and Y2=106.07.

In the light scanning apparatus 60 according to the present embodiment, it is preferred that the above-described Inequality (9) be satisfied for each of the first light flux and the second light flux.

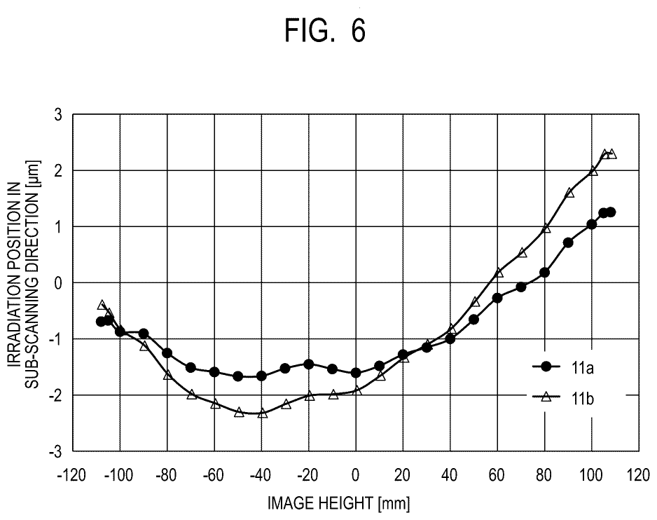

FIG. 6 shows scanning lines formed on the surface to be scanned 9 when a normal of the deflecting surface 5a of the polygon mirror 5 is tilted by an angle of 2′ with respect to the main scanning cross section in a cross section which includes the normal and is parallel to the sub-scanning direction in the light scanning apparatus 60 according to the present embodiment.

Specifically, the vertical axis of FIG. 6 indicates a coordinate in the sub-scanning direction of a reaching position of a light flux on the surface 9, and the horizontal axis of FIG. 6 indicates an image height.

Note that the scanning line formed by the first light flux and that formed by the second light flux are shifted from each other by about one pixel, but the shift is removed in FIG. 6.

As shown in FIG. 6, in the light scanning apparatus 60 according to the present embodiment, for the first light flux, Inequality (9) is satisfied since Z3=−0.69 μm, Z4=1.26 μm and Z0=−1.67 μm (at the image height of −50 mm).

Further, for the second light flux, Inequality (9) is satisfied since Z3=−0.39 μm, Z4=2.30 μm and Z0=−2.32 μm (at the image height of −40 mm).

In the light scanning apparatus 60 according to the present embodiment, it is preferred that the above-described Inequality (10) be satisfied.

As described above, the light source 11 has the first light emitting point 11a and the second light emitting point 11b in the light scanning apparatus 60 according to the present embodiment.

A part of the first light flux emitted from the first light emitting point 11a is vignetted when deflected by the deflecting surface 5a so as to scan the vicinity of the outermost off-axis image height on the positive side in the main scanning direction on the surface to be scanned 9.

On the other hand, the first light flux is not vignetted even if it is deflected by the deflecting surface 5a so as to scan any of image heights on the negative side in the main scanning direction on the surface 9.

Further, a part of the second light flux emitted from the second light emitting point 11b is vignetted when deflected by the deflecting surface 5a so as to scan the vicinity of the outermost off-axis image height on the negative side in the main scanning direction on the surface 9.

On the other hand, the second light flux is not vignetted even if it is deflected by the deflecting surface 5a so as to scan any of image heights on the positive side in the main scanning direction on the surface 9.

Thereby, a region where the partially vignetted first light flux reaches on the positive side in the main scanning direction on the surface 9 and that where the partially vignetted second light flux reaches on the negative side in the main scanning direction on the surface 9 can be made substantially the same as each other.

As a result, it is possible to reduce an amount of vignetting of the light flux on each of the positive side and the negative side in the main scanning direction on the surface 9.

That is, in the light scanning apparatus 60 according to the present embodiment, Inequality (10) is satisfied since n1=1 and n2=1.

Although the light source 11 having two light emitting points is used in the light scanning apparatus 60 according to the present embodiment, the present disclosure is not limited thereto, and a light source having four light emitting points may be used in order to increase a definition of an image.

For example, a resolution in the sub-scanning direction is doubled when a light source having four light emitting points arranged at intervals of 30 μm on a straight line in a direction rotated counterclockwise by 5.4° with respect to the main scanning cross section as viewed from a polygon mirror 5 side in a direction parallel to the optical axis of the incident optical system 6 is used.

Here, a light emitting point most distant from the surface to be scanned 9 in a direction perpendicular to the optical axis of the incident optical system 6 is referred to as a first light emitting point, and a light emitting point closest to the surface 9 in the direction is referred to as a second light emitting point in the light source having the four light emitting points.

Further, a light emitting point adjacent to the first light emitting point is referred to as a third light emitting point, and a light emitting point adjacent to the second light emitting point is referred to as a fourth light emitting point on the straight line on which the four light emitting points are arranged.

Furthermore, light fluxes emitted from the first, second, third and fourth light emitting points are referred to as first, second, third and fourth light fluxes, respectively.

Similarly to the light source 11, the light source having the four light emitting points is arranged so as to be shifted by 0.26 mm in an orientation away from the surface 9 in the direction perpendicular to the optical axis of the incident optical system 6.

At this time, a part of only the first light flux among the first to fourth light fluxes is vignetted when they are deflected by the deflecting surface 5a so as to scan the outermost off-axis image height on the positive side in the main scanning direction on the surface 9.

On the other hand, a part of each of the second and fourth light fluxes among the first to fourth light fluxes is vignetted when they are deflected by the deflecting surface 5a so as to scan the outermost off-axis image height on the negative side in the main scanning direction on the surface 9.

Specifically, a part of the fourth light flux is vignetted when deflected by the deflecting surface 5a so as to reach a region between an image height of −107.88 mm and the outermost off-axis image height of −108.00 mm on the negative side in the main scanning direction on the surface 9.

Then, 0.1% of the incident light flux is vignetted when the fourth light flux deflected by the deflecting surface 5a so as to reach the outermost off-axis image height of −108.00 mm on the negative side in the main scanning direction on the surface 9.

That is, even in a case where the light source having four light emitting points as described above is used instead of the light source 11 in the light scanning apparatus 60 according to the present embodiment, Inequality (10) is satisfied since n1=1 and n2=2.

Thereby, a region where the partially vignetted first light flux reaches on the positive side in the main scanning direction on the surface 9 and that where the partially vignetted second light flux reaches on the negative side in the main scanning direction on the surface 9 can be made substantially the same as each other.

As a result, it is possible to reduce an amount of vignetting of the light flux on each of the positive side and the negative side in the main scanning direction on the surface 9.

Further, in the light scanning apparatus 60 according to the present embodiment, it is preferred that the above-described Inequality (11) be satisfied, and Inequality (11) is satisfied since θ=87.5° and N=5.

Furthermore, in the light scanning apparatus 60 according to the present embodiment, it is preferred that the above-described Inequality (12) be satisfied, and Inequality (12) is satisfied since L=84.4, Y3=108.00 and Y4=108.00.

As described above, in the light scanning apparatus 60 according to the present embodiment, it is possible to suppress deterioration in image quality due to an unevenness in density generated on the surface to be scanned 9 by performing an adjustment such that a light flux is appropriately vignetted by the small polygon mirror 5 so as to satisfy the above-described Inequality (8).

Values of Inequalities for the light scanning apparatuses according to the first and second embodiments are shown in the following Table 10.

TABLE 10

| | First | Second |
|---|---|---|
| | embodiment | embodiment |
| Inequality (6): Y3 − Y1 ≤ 5.00 | 2.96 | 1.45 |
| Inequality (6a): Y3 − Y1 ≤ 3.00 | | |
| Inequality (7): Y4 − Y2 ≤ 5.00 | 2.98 | 1.93 |
| Inequality (7a): Y4 − Y2 ≤ 3.00 | | |
| Inequality (8): −0.005 ≤ (Y2 − Y1)/(Y2 + Y1) ≤ 0.005 | −0.0001 | −0.002 |
| Inequality (8a): −0.003 ≤ (Y2 − Y1)/(Y2 + Y1) ≤ 0.003 | | |
| Inequality (8b): −0.002 ≤ (Y2 − Y1)/(Y2 + Y1) ≤ 0.002 | | |
| Inequality (9): 0.30 ≤ (Z3 + Z4)/{Z0 + Max(Z3, Z4)} ≤ 0.82 | 0.81 | 0.58 |
| Inequality (11): (720/N)/(N − 1) + 45 < 0 < (720/N)/(N − 1) + 60 | 81 < 87.5 < 96 | 81 < 87.5 < 96 |
| Inequality (12): 0.30 ≤ L/W ≤ 0.70 | 0.39 | 0.39 |

According to the present disclosure, a compact light scanning apparatus employing a UFS method can be provided.

### [Monochrome Image Forming Apparatus]

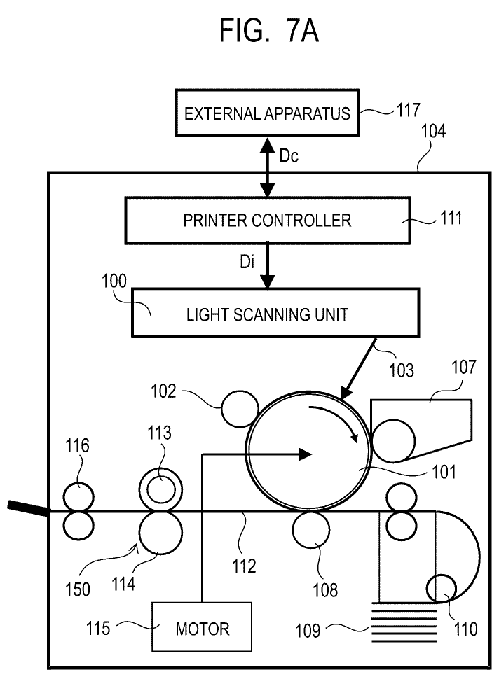

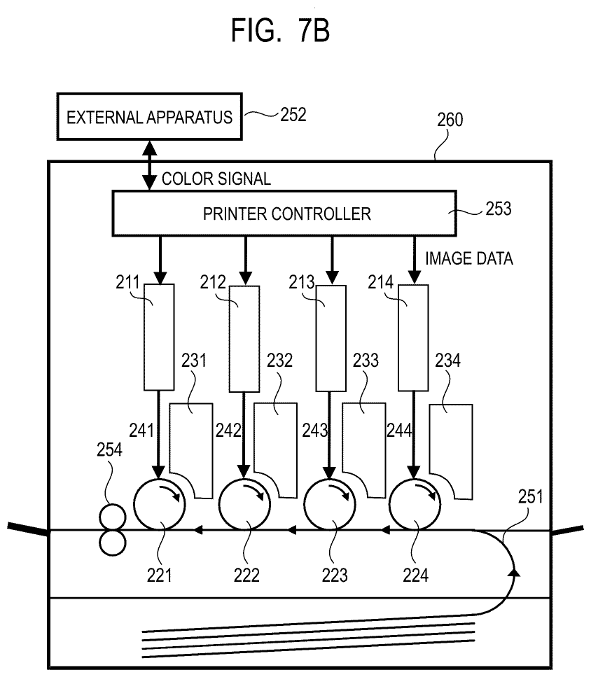

FIG. 7A shows a schematic sub-scanning cross sectional view of a main part of a monochrome image forming apparatus 104 including the light scanning apparatus according to the first or second embodiment.

Code data Dc output from an external apparatus 117 such as a personal computer is input to the monochrome image forming apparatus 104.

The input code data Dc is converted into image data (dot data) Di by a printer controller 111 in the monochrome image forming apparatus 104.

Next, the image data Di is input to a light scanning unit 100 which is the light scanning apparatus according to the first or second embodiment.

A light beam 103 modulated according to the image data Di is emitted from the light scanning unit 100, and a photosensitive surface of a photosensitive drum 101 is scanned in the main scanning direction by the emitted light beam 103.

The photosensitive drum 101 serving as an electrostatic latent image bearing body (photosensitive body) is rotated clockwise by a motor 115.

When the photosensitive drum 101 rotates in this way, the photosensitive surface of the photosensitive drum 101 moves in the sub-scanning direction with respect to the light beam 103.

A charging roller 102 for uniformly charging the photosensitive surface of the photosensitive drum 101 is provided above the photosensitive drum 101 so as to abut on the photosensitive surface.

The photosensitive surface of the photosensitive drum 101 charged by the charging roller 102 is irradiated with the light beam 103 scanned by the light scanning unit 100.

As described above, the light beam 103 is modulated based on the image data Di, and an electrostatic latent image is formed on the photosensitive surface of the photosensitive drum 101 by irradiation with the modulated light beam 103.

Then, the formed electrostatic latent image is developed as a toner image by a developing unit 107 arranged so as to abut on the photosensitive drum 101 on the downstream side of the irradiation position of the light beam 103 in the rotation direction of the photosensitive drum 101.

The toner image developed by the developing unit 107 is transferred onto a sheet 112 as a transferred material by a transferring roller 108 arranged below the photosensitive drum 101 so as to face the photosensitive drum 101.

The sheet 112 is stored in a sheet cassette 109 in front of the photosensitive drum 101 (on the right side in FIG. 7A), but may be manually fed.

A paper feeding roller 110 is arranged at an end portion of the sheet cassette 109, and the sheet 112 in the sheet cassette 109 is fed to a conveyance path by the paper feeding roller 110.

The sheet 112 to which the unfixed toner image has been transferred as described above is further conveyed to a fixing unit 150 provided behind the photosensitive drum 101 (on the left side in FIG. 7A).

The fixing unit 150 is formed by a fixing roller 113 having a fixing heater (not shown) therein and a pressurizing roller 114 arranged so as to be in pressure contact with the fixing roller 113.

Then, the sheet 112 conveyed from the transferring roller 108 is heated while being pressed at a pressure contact portion between the fixing roller 113 and the pressurizing roller 114, thereby the unfixed toner image on the sheet 112 is fixed.

Further, a sheet discharging roller 116 is arranged behind the fixing unit 150, and the sheet 112 on which the toner image has been fixed is discharged to outside of the monochrome image forming apparatus 104 by the sheet discharging roller 116.

Although not shown in FIG. 7A, the printer controller 111 performs not only the above-described data conversion but also control of each member in the monochrome image forming apparatus 104 such as the motor 115, a polygon motor in the light scanning unit 100, and the like.

A recording density of the monochrome image forming apparatus 104 is not particularly limited, but high image quality is required in accordance with improvement of the recording density.

Therefore, the above-described structure of the light scanning unit 100, which is the light scanning apparatus according to the first or second embodiment, is effective when the recording density of the monochrome image forming apparatus 104 is 1200 dpi or more.

### [Color Image Forming Apparatus]

FIG. 7B shows a schematic sub-scanning cross sectional view of a main part of a color image forming apparatus 260 including the light scanning apparatus according to the first or second embodiment of the present disclosure.

The color image forming apparatus 260 is a tandem-type color image forming apparatus in which four light scanning apparatuses according to the first or second embodiment record image information on photosensitive surfaces of photosensitive drums as four image bearing bodies in parallel, respectively.

The color image forming apparatus 260 includes light scanning apparatuses 211, 212, 213 and 214 according to the first or second embodiment, and photosensitive drums 221, 222, 223 and 224.

Further, the color image forming apparatus 260 includes developing units 231, 232, 233 and 234, a conveying belt 251, a printer controller 253 and a fixing unit 254.

As shown in FIG. 7B, color signals of R (red), G (green), and B (blue) output from an external apparatus 252 such as a personal computer are input to the color image forming apparatus 260.

The input color signals are converted into image data (dot data) of C (cyan), M (magenta), Y (yellow), and K (black) by a printer controller 253 provided in the color image forming apparatus 260.

Next, the image data is input to the light scanning apparatuses 211, 212, 213 and 214, and light beams 241, 242, 243 and 244 modulated in accordance with the image data are emitted from the light scanning apparatuses 211, 212, 213 and 214.

The respective photosensitive surfaces of the photosensitive drums 221, 222, 223 and 224 are scanned in the main scanning direction by the emitted light beams 241, 242, 243 and 244.

A charging roller (not shown) for uniformly charging the photosensitive surface of each of the photosensitive drums 221, 222, 223 and 224 is provided so as to abut on the photosensitive surface.

The photosensitive surfaces of the photosensitive drums 221, 222, 223 and 224 charged by the charging rollers are irradiated with light beams 241, 242, 243 and 244 by the light scanning apparatuses 211, 212, 213, and 214.

As described above, the light beams 241, 242, 243 and 244 are modulated based on the image data of each color, and electrostatic latent images are formed on the photosensitive surfaces of the photosensitive drums 221, 222, 223 and 224 by irradiating the photosensitive drums with the light beams 241, 242, 243 and 244.

The formed electrostatic latent images are developed as toner images by developing units 231, 232, 233 and 234 arranged so as to abut on the photosensitive drums 221, 222, 223 and 224.

Next, the toner images developed by the developing units 231 to 234 are multiply transferred onto a sheet (transferred material) (not shown) conveyed on the conveying belt 251 by a transferring roller (transferring unit) (not shown) arranged to face the photosensitive drums 221 to 224. Thereby, one full-color image is formed.

The sheet on which the unfixed toner image has been transferred is further conveyed to the fixing unit 254 provided behind the photosensitive drums 221, 222, 223 and 224 (on the left side in FIG. 7B).

The fixing unit 254 is formed by a fixing roller having a fixing heater (not shown) therein and a pressurizing roller arranged so as to be in pressure contact with the fixing roller.

Then, the sheet conveyed from the transferring roller is heated while being pressed by a pressure contact portion between the fixing roller and the pressurizing roller, thereby the unfixed toner image on the sheet is fixed.

Further, a sheet discharging roller (not shown) is arranged behind the fixing unit 254, and the sheet discharging roller discharges the fixed sheet to outside of the color image forming apparatus 260.

The light scanning apparatuses 211, 212, 213 and 214 correspond to the respective colors of C (cyan), M (magenta), Y (yellow), and K (black).

The light scanning apparatuses 211, 212, 213 and 214 record image signals (image information) on the photosensitive surfaces of the photosensitive drums 221, 222, 223 and 224 in parallel, respectively, thereby printing a color image at high speed.

As the external apparatus 252, a color image reading apparatus including a CCD sensor may be used, for example.

In this case, a color digital copying machine is formed by the color image reading apparatus and the color image forming apparatus 260.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-184625, filed Oct. 21, 2024, which is hereby incorporated by reference herein in its entirety.

What is claimed is:

1. A light scanning apparatus, comprising:
a deflecting unit configured to deflect a light flux from a light source to scan a surface in a main scanning direction; and
a first optical system configured to guide the light flux deflected by the deflecting unit to the surface to be scanned,
wherein a width of the light flux immediately before being incident on the deflecting unit is smaller than a width of a deflecting surface of the deflecting unit in a main scanning cross section,
wherein only a part of the light flux incident on the deflecting unit reaches a plurality of image heights on the surface to be scanned via the deflecting surface in the main scanning cross section, and
wherein the following inequality is satisfied:
$$- 0.005 \leq ( Y 2 - Y 1 ) / ( Y 2 + Y 1 ) \leq 0.005$$
where Y1 (mm) represents a distance between an on-axis image height and an image height closest to the on-axis image height on one side with respect to the on-axis image height among the plurality of image heights, and Y2 (mm) represents a distance between the on-axis image height and an image height closest to the on-axis image height on the other side with respect to the on-axis image height among the plurality of image heights.

2. The light scanning apparatus according to claim 1, wherein the following inequalities are satisfied:
$$Y 3 - Y 1 \leq 5.$$
$$Y 4 - Y 2 \leq 5.$$
where Y3 (mm) represents a distance between a first outermost off-axis image height on the one side and the on-axis image height, and Y4 (mm) represents a distance between a second outermost off-axis image height on the other side and the on-axis image height.

3. The light scanning apparatus according to claim 1, further comprising a second optical system configured to cause the light flux from the light source to be incident on the deflecting unit,
wherein a center of a light emitting surface of the light source is not on an optical axis of the second optical system when projected onto the main scanning cross section.

4. The light scanning apparatus according to claim 3, wherein the center of the light emitting surface is arranged on a side opposite to the surface to be scanned with respect to a cross section including the optical axis of the second optical system and parallel to a sub-scanning direction.

5. The light scanning apparatus according to claim 1, wherein the following inequality is satisfied when an angle formed by a normal of the deflecting surface with respect to the main scanning cross section in a cross section including the normal and parallel to a sub-scanning direction is 2′:
$$0.3 \leq ( Z 3 + Z 4 ) / \{ Z 0 + Max ( Z 3 , Z 4 ) \} \leq 0.82$$
where Z3 represents a distance in the sub-scanning direction between an optical axis of the first optical system and a reaching position of the light flux deflected by the deflecting surface at a first outermost off-axis image height on the one side, Z4 represents a distance in the sub-scanning direction between the optical axis of the first optical system and a reaching position of the light flux deflected by the deflecting surface at a second outermost off-axis image height on the other side, and Z0 represents a distance in the sub-scanning direction between the optical axis of the first optical system and a reaching position most distant in the sub-scanning direction from the reaching position at one of the first and second outermost off-axis image heights corresponding to a larger one of Z3 and Z4 among reaching positions of respective light fluxes deflected by the deflecting surface at respective image heights.

6. The light scanning apparatus according to claim 1, wherein a number of light emitting points included in the light source is one.

7. The light scanning apparatus according to claim 1,
wherein the light source has a plurality of light emitting points including first and second light emitting points,
wherein, in the main scanning cross section, when a normal of the deflecting surface forms a first angle with respect to an optical axis of the first optical system, only a part of a first light flux from the first light emitting point incident on the deflecting unit is deflected by the deflecting surface to reach a first outermost off-axis image height on the one side, whereas all of a second light flux from the second light emitting point incident on the deflecting unit is deflected by the deflecting surface to reach the first outermost off-axis image height, and
wherein, in the main scanning cross section, when the normal of the deflecting surface forms a second angle with respect to the optical axis of the first optical system, all of the first light flux incident on the deflecting unit is deflected by the deflecting surface to reach a second outermost off-axis image height on the other side, whereas only a part of the second light flux incident on the deflecting unit is deflected by the deflecting surface to reach the second outermost off-axis image height.

8. The light scanning apparatus according to claim 7,
wherein the light source is arranged on the one side, and
wherein the following inequality is satisfied:
$$1 \leq n 1 \leq n 2$$
where n1 represents a number of light fluxes only a part of each of which is deflected by the deflecting surface and reach the first outermost off-axis image height among a plurality of light fluxes from the plurality of light emitting points incident on the deflecting unit when the normal of the deflecting surface is at the first angle, in the main scanning cross section, and n2 represents a number of light fluxes only a part of each of which is deflected by the deflecting surface and reach the second outermost off-axis image height among the plurality of light fluxes incident on the deflecting unit when the normal of the deflecting surface is at the second angle, in the main scanning cross section.

9. The light scanning apparatus according to claim 1, further comprising a second optical system configured to cause the light flux from the light source to be incident on the deflecting unit,
wherein the following inequality is satisfied:
$$( 720 / N ) / ( N - 1 ) + 45 < θ < ( 720 / N ) / ( N - 1 ) + 60$$
where N represents a number of deflecting surfaces, and θ (°) represents an angle between an optical axis of the first optical system and an optical axis of the second optical system in the main scanning cross section.

10. The light scanning apparatus according to claim 1, further comprising a second optical system configured to cause the light flux from the light source to be incident on the deflecting unit,
wherein the following inequality is satisfied:
$$0.3 \leq L / W \leq 0.70$$
where L represents a distance on an optical axis of the second optical system between a light emitting surface of the light source and an on-axis deflection point on the deflecting surface, and W represents a distance between a first outermost off-axis image height on the one side and a second outermost off-axis image height on the other side.

11. The light scanning apparatus according to claim 1, wherein the deflecting unit is a polygon mirror configured to rotate around a rotation axis.

12. A light scanning apparatus, comprising:
a deflecting unit configured to deflect a light flux from a light source to scan a surface in a main scanning direction; and
a first optical system configured to guide the light flux deflected by the deflecting unit to the surface to be scanned,
wherein a width of the light flux immediately before being incident on the deflecting unit is smaller than a width of a deflecting surface of the deflecting unit in a main scanning cross section, and
wherein only a part of the light flux incident on the deflecting unit is deflected by the deflecting surface to reach the surface to be scanned when a normal of the deflecting surface forms a predetermined angle with respect to an optical axis of the first optical system in the main scanning cross section.

13. An image forming apparatus, comprising:
the light scanning apparatus according to claim 1; and
a developing unit configured to develop an electrostatic latent image formed on the surface to be scanned by the light scanning apparatus.

14. An image forming apparatus, comprising:
the light scanning apparatus according to claim 1; and
a controller configured to convert a signal output from an external apparatus into image data and input the image data to the light scanning apparatus.
